(19) United States
(12) Patent Application Publication
(10) Pub. No.: US 2026/0187682 A1
(43) Pub. Date: Jul. 2, 2026

(54) System and Method for Automatic Creation of Videos that Seamlessly Contain Advertisement Components Using Artificial Intelligence (AI) Based Placement Harmonization

(71) Applicant: CLOUDINARY LTD., Petah Tikva (IL)

(72) Inventors: Yaron Shmueli, Kfar Saba (IL); Amnon Cohen-Tidhar, Zoran (IL); Tal Lev-Ami, Modiin (IL)

(21) Appl. No.: 19/006,362

(22) Filed: Dec. 31, 2024

(51) Int. Cl. G06Q 30/0241; G06T 11/60; H04N 21/234

(52) U.S. Cl. CPC G06Q 30/0276; G06T 11/60; H04N 21/23424; G06T 2211/441

(57) ABSTRACT

A computerized method performs an automatic look-and-feel harmonization process, between (i) a target video, and (ii) an advertisement video that is intended for temporal insertion into the target video; by automatically modifying visual characteristics of the advertisement video to increase a level of visual matching between the target video and the advertisement video, and by generating a harmonized version of the advertisement video that is tailored to suitably match the look-and-feel of the target video. An Artificial Intelligence (AI) model is invoked to automatically analyze content of the target video, and to determine a particular time-point in the target video at which the harmonized version of the advertisement video can be suitably inserted via temporal insertion. Additionally or alternatively, the method performs spatial insertion of advertisement content into particular image-regions of particular video-frames of the target video.

### FIELD

Some embodiments are related to the field of digital content creation, and particularly to the field of creation of digital images and digital videos.

### BACKGROUND

Electronic devices and computing devices are utilized on a daily basis by millions of users worldwide. For example, laptop computers, desktop computers, smartphone, tablets, and other electronic devices are utilized for browsing the Internet, consuming digital content, streaming audio and video, sending and receiving electronic mail (email) messages, engaging in Instant Messaging (IM) and video conferences, playing games, or the like.

Digital images and digital videos are often sent and received among users, are posted or shared by users via social networks, and are part of content shown on a variety of websites.

### SUMMARY

Some embodiments include systems, devices, and methods for automatic creation and/or modification and/or generation of videos, that seamlessly contain advertisement components or promotional components or a particular product-of-interest, using Artificial Intelligence (AI) based placement harmonization and/or optimization.

For example, a computerized method performs an automatic look-and-feel harmonization process, between (i) a target video, and (ii) an advertisement video that is intended for temporal insertion into the target video; by automatically modifying visual characteristics of the advertisement video to increase a level of visual matching between the target video and the advertisement video, and by generating a harmonized version of the advertisement video that is tailored to suitably match the look-and-feel of the target video. An Artificial Intelligence (AI) model is invoked to automatically analyze content of the target video, and to determine a particular time-point in the target video at which the harmonized version of the advertisement video can be suitably inserted via temporal insertion. Additionally or alternatively, the method performs spatial insertion of advertisement content into particular image-regions of particular video-frames of the target video.

Some embodiments provide a computerized method comprising: (a) automatically performing a look-and-feel harmonization process, between (i) a target video, and (ii) an advertisement video that is intended for insertion into said target video, by automatically modifying visual characteristics of the advertisement video to increase a level of visual matching between the target video and the advertisement video, and by generating a harmonized version of the advertisement video that is tailored to suitably match the look-and-feel of the target video; (b) invoking an Artificial Intelligence (AI) model to automatically analyze content of the target video, and to determine a particular time-point in the target video at which the harmonized version of the advertisement video can be suitably inserted via temporal insertion; (c) performing temporal insertion of the harmonized version of the advertisement video into the target video, at said particular time-point in the target video, to generate a combined and harmonized video output.

Some embodiments provide a computer-based method, comprising: (a) automatically performing a look-and-feel harmonization process, between (i) a target video, and (ii) an advertisement product-image that is intended for spatial insertion into some video-frames of said target video, by automatically modifying visual characteristics of the advertisement product-image to increase a level of visual matching between the target video and the advertisement product-image, and by generating a harmonized version of the advertisement product-image that is tailored to suitably match the look-and-feel of the target video; (b) invoking an Artificial Intelligence (AI) model to automatically analyze content of the target video, and to determine particular video-frames of the target video that have frame-regions that the AI model determines to be suitable for adding therein the harmonized version of the advertisement product-image; wherein said adding comprises an in-frame spatial insertion that is one of: (i) adding into a frame-region that is not occupied by another object, (ii) replacing an object in said particular video-frames with the harmonized version of the advertisement product-image; (c) performing spatial insertion of the harmonized version of the advertisement product-image into the target video, at said frame-regions of said particular video-frames.

Some embodiments may provide other and/or additional benefits and/or advantages.

### BRIEF DESCRIPTION OF THE DRAWINGS

FIG. 1 is a schematic block-diagram illustration of a system for client-side harmonized insertion of an advertisement component into a target video, in accordance with some demonstrative embodiments.

FIG. 2 is a schematic block-diagram illustration of a server-side based Advertisement Insertion System, in accordance with some demonstrative embodiments.

FIG. 3 is a flow-chart of a method of video advertisement harmonization, in accordance with some demonstrative embodiments.

FIG. 4 is a flow-chart of a method of configuration of video advertisement harmonization, in accordance with some demonstrative embodiments.

FIG. 5 is a flow-chart demonstrating in greater detail the video harmonization process, in accordance with some demonstrative embodiments.

FIG. 6 is a flow-chart demonstrating the preparation of video for streaming, in accordance to some demonstrative embodiments.

FIG. 7 is a flow-chart demonstrating the utilization of Generative AI to create transitioning scenes or transitioning effects, in accordance with some demonstrative embodiments.

FIG. 8 is a flow-chart demonstrating harmonizing the look-and-feel of the advertisement content, to better match the look-and-feel of the target video, in accordance with some demonstrative embodiments.

FIG. 9 is a flow-chart demonstrating automatic determination of a most-suitable time-point, in the target video, at which the advertisement video would be temporally inserted, in accordance with some demonstrative embodiments.

FIG. 10 is schematic block-diagram illustration of a system for video advertisement insertion and harmonization, in accordance with some demonstrative embodiments.

FIG. 11 is a flow-chart demonstrating automatic detection loops over each product of advertisement content, in accordance with some demonstrative embodiments.

FIG. 12 is a flow-chart demonstrating determination of object placeholder(s) in a target video, in accordance with some demonstrative embodiments.

### DETAILED DESCRIPTION OF SOME DEMONSTRATIVE EMBODIMENTS

The Applicant has realized that video/image advertisement insertion systems can be improved or enhanced or optimized, by using Artificial Intelligence (AI) based tools and units, to achieve high-quality, seamless, and harmonized placement or addition or insertion of advertisement components into videos or images.

For example, a system selects an advertisement component that is then inserted into a video clip (“target video”) at a particular time-point. The advertisement component reflects the vendor's (maker's, manufacturer's, distributor's) brand, look-and-feel, marketing concepts, and other brand-related features or ideas. The Applicant has realized that the advertisement component sometimes has no correlation at all, or poor or low correlation, to the video context or to the look-and-feel of the target video. For example, an advertisement component of a bottle of Coca Cola has a distinct look (e.g., red-and-white logo over a bottle that is generally black); whereas the target video may be a video of people at the beach that features mainly yellow sand and blue water; with no or poor correlation among colors. Furthermore, realized the Applicant, the bottle of Coca Cola is typically provided by the vendor (or the advertiser) as a standard image (or video segment) that was shot in ideal lighting conditions in a photo studio; whereas the target video (or target image) often has shades from the sun or a light-source, and/or has shades of varying colors due to illumination or sunset or sunrise as may be featured in the target video/image. The visual mismatch from an agnostic placement of the advertisement component into a target video/image, realized the Applicant, causes an abrupt or intrusive or degraded viewing experience to the viewer; and/or also causes the viewer to recognize that the advertisement component was artificially or synthetically added to a pre-existing video/image.

Some embodiments may solve, prevent, cure or mitigate such problems, and may improve the viewing experience for users that observe a video/image into which an advertisement component was automatically inserted or added; by preventing or reducing or minimizing such intrusiveness, and while avoiding or preventing or reducing any breaking of the video/image context. Some embodiments may be implemented using an Advertisement Insertion Harmonization Unit or module, that can be added to a conventional advertisement insertion system, targeting smoother transition to and from the advertisement component.

The Advertisement Insertion Harmonization Unit can be a stand-alone system or device or module, or a stand-alone application or “app” or program that runs on a computer computing device. Additionally or alternatively, the Advertisement Insertion Harmonization Unit can be an add-on or extension or plug-in module to an existing or conventional or other Advertisement Insertion system or program, or to a video editing/video generation program or system, or to an image editing/image generation program or system. Additionally or alternatively, the Advertisement Insertion Harmonization Unit can be implemented as a browser extension, or as a web-friendly application or app that runs within a web browser (e.g., using JavaScript, HTML5, CSS, client-side scripts or components, server-side scripts or components). Additionally or alternatively, the Advertisement Insertion Harmonization Unit can be implemented as an extension or addition to a Generative AI or Gen-AI system, which may run locally on a computing device and/or may run remotely on a remote server or a cloud-computing server, augmenting the capabilities of such Gen-AI system to harmonize and visually improve its AI-generated outputs.

In some embodiments, the advertisement component can be added or inserted into a target video on the Temporal Domain, such as at a particular time-point within the target video; optionally with a smooth and harmonized transition video-segment before and/or after the inserted advertisement component. Additionally or alternatively, in some embodiments, advertisement component can be added or inserted into a target video (or into a target image) on the Spatial Domain the, such as, adding a particular product onto a table in the video/image, replacing an existing item in the video/image with a particular product, replacing a make-and-model of a particular product in the video/image with another make-and-model product, or the like. In some embodiments, a target video may be modified both temporally and spatially; for example, by adding new video frames or a new video segment at a particular time-point in the target video (temporal insertion), and also by adding an advertisement product by placing it visually into particular already-existing video-frames or video-segments of the target video.

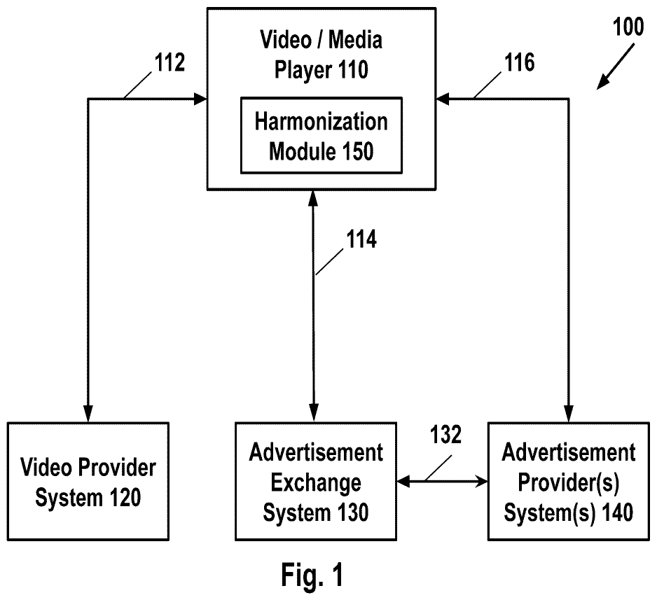

Reference is made to FIG. 1, which is a schematic block-diagram illustration of a system 100 for client-side harmonized insertion of an advertisement component into a target video, in accordance with some demonstrative embodiments.

For example, the system includes a video provider system 120 that provides or delivers the video content (the target video) to the video viewing platform, which may be a television, a web page, a social network/social media application or page, a web browser, a smartphone, a tablet, a desktop computer, a laptop computer, a gaming console or gaming device, an Augmented Reality (AR)/Virtual Reality (VR)/Mixed Reality (MR or XR) device or helmet or headgear or glasses, a content viewing kiosk or screen that may be located indoors or outdoors, a digital billboard, a wearable and/or portable electronic device, a vehicular dashboard or vehicular entertainment unit, a screen or entertainment unit that is part of a vehicle or aircraft or train or marine vessel, or other video consumption/image consumption/digital content consumption electronic device. In some embodiments, the combination of the video (or image) with the harmonized advertisement content can be displayed or played or streamed or consumed via other suitable devices, such as, television, cinema, over-the-air broadcast, or other suitable presentation means.

The viewing device or viewing platform includes a Video/Media Player 110 or playback component, which connects to the Video Provider System 120, requesting the target video (arrow 112); receives its packets from the network and performs parsing, decodes the incoming video or digital content, enables the advertisement(s) insertion (in the spatial domain and/or in the temporal domain), and further enables user control over the video (e.g., start, stop, pause, fast-forward, remind). The Video/Media Player 110 connects (arrow 114) to an Advertisement Exchange System 130, and requests from it an advertisement component. The Advertisement Exchange System 130, in turn, connects (arrow 132) to one or more systems 140 of advertisements providers, and selects a specific advertisement component from a particular advertisement provider. The Advertisement Exchange System 130 generates a document or a dataset or a file or a list or other digital record, that represents or indicates the streaming details of the advertisement's media, and delivers it (arrow 114) back to the Video/Media Player 110.

The Video/Media Player 110 connects (arrow 116) to the Advertisement Provider System 140, to request the advertisement media (the advertisement component, the advertisement content) for streaming. The Advertisement Provider System 140 delivers the advertisement content to the Video/Media Player 140, which dynamically inserts the advertisement content during the video viewing session. In some embodiments, the above is performed in real-time or in near-real-time, immediately triggered by the initial request from the Video/Media player 110 to consume a particular target video.

In accordance with some embodiments, a Harmonization Module 150 (or, a video harmonization module; or, an image harmonization module; or, an advertisement harmonization module; or, an advertisement content harmonization module) is part of system 100. For demonstrative purposes and as a non-limiting example, Harmonization Module 150 is shown as part of Video/Media Player 110; however, the Harmonization Module 150 can be implemented as a stand-alone unit or as another module that can be operably associated and/or communicatively associated with any other component(s) of system 100, instead of or in addition to being part of (or being associated with) the Video/Media Player 110.

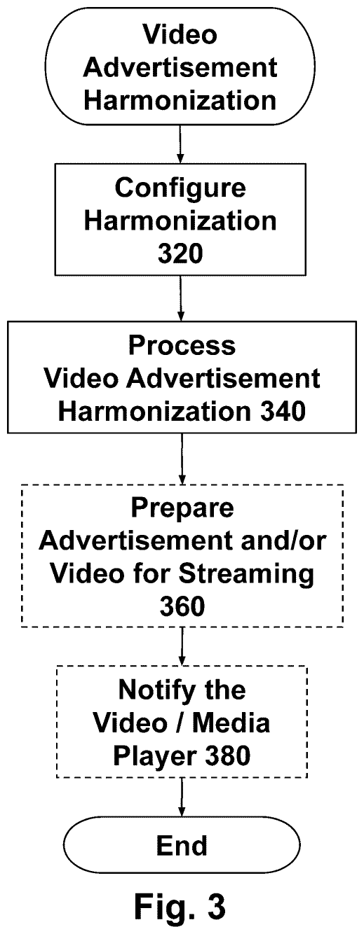

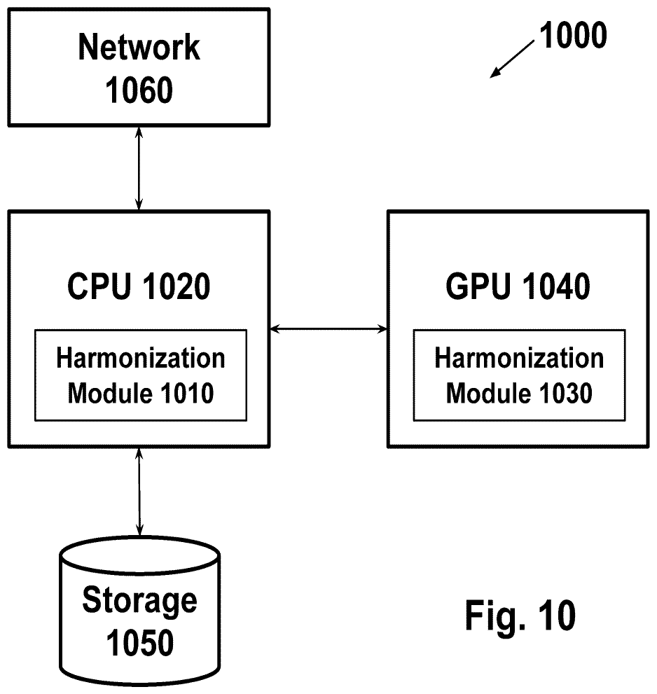

In some embodiments, Harmonization Module 150 is entirely a client-side implementation/module, as described herein with reference to FIG. 3. The Harmonization Module 150 may utilize client-side resources, as described herein with reference to FIG. 10. Once the Video / Media Player 110 retrieves both the target video and advertisement content, the Harmonization Module 150 can process the advertisement content insertion into the target video in a seamless and harmonized manner as described herein.

Additionally or alternatively, another flow of operations can be implemented to automatically add advertisement content (e.g., a product) spatially into specific video frames of the target video. For example, the Video/Media Player 110 connects (arrow 114) to the Advertisement Exchange System 130, requesting an advertisement product image. The Advertisement Exchange System 130 connects (arrow 132) to one or more Advertisement Provider System(s) 140, and selects a specific advertisement provider and advertisement product, or can even select multiple vendors and/or multiple advertisement products. The Advertisement Exchange System 130 generates a document or dataset or other digital record that represents or indicates the streaming details of the advertisement product(s) image(s), and delivers it (arrow 114) back to the Video/Media Player 110. Then, the Video Media Player 110 connects (arrow 116) to the one or more indicated Advertisement Provider System(s) 140, to request from it/from them the advertisement products image(s) for client-side insertion into video-frames. Each of such relevant Advertisement Provider System 140 delivers each such advertisement product image directly to the client-side Video/Media Player 110, which locally (client-side) inserts the advertisement product image into specific video frames during the video viewing session and/or immediately prior to such viewing session. The Harmonization Module 150 can thus be added to the viewing system, as part of the Video Media Player 110 or as a unit or component that is operatively or communicatively associated therewith. The Harmonization Module 150 is a pure client-side implementation, as described herein with reference to FIG. 3; and it can utilize client-side resources as described herein with reference to FIG. 10. Once the Video/Media Player 110 retrieves both the target video and advertisement content, it can locally (client-side) process and perform the harmonized advertisement insertion into frames of the target video, during playback or during the content consumption, or immediately prior to such playback or consumption.

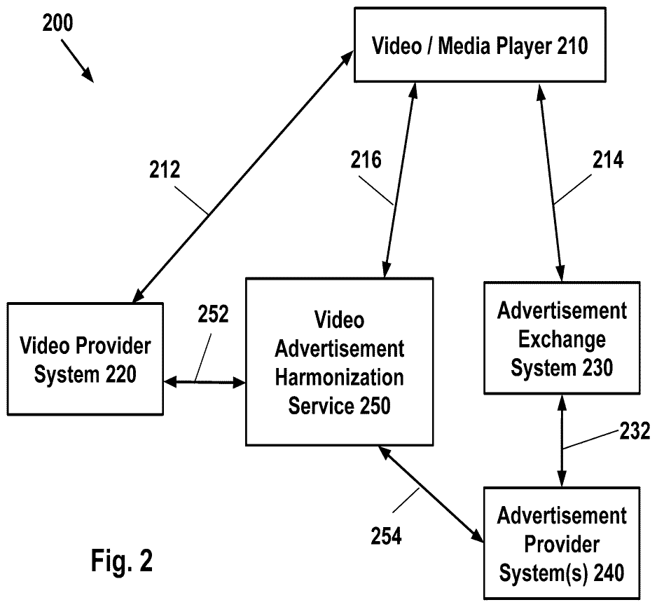

Reference is made to FIG. 2, which is a schematic block-diagram illustration of a server-side based Advertisement Insertion System 200, in accordance with some demonstrative embodiments. It comprises a Video Advertisement Harmonization Service 250, shown as an independent or discrete component that can be otherwise implemented as part of another component of system 200 and/or as a service or unit that is operatively and/or communicatively associated with one or more components of system 200.

The system includes a Video/Media Player 210 that connects to a Video Provider System 220, requesting (arrow 212) from the Video Provider System 220 a target video stream. The Video/Media Player 210 also connects to an Advertisement Exchange System 230, requesting (arrow 214) an advertisement component. The Advertisement Exchange System 230 then connects (arrow 232) to one or more Advertisement Provider System(s) 240, and receives or selects therefrom a particular advertisement of a particular advertiser. The Advertisement Exchange System 230 generates a document or dataset or other digital record that represents or indicate the streaming details of the advertisement component's media; and delivers it (arrow 214) back to the Video/Media Player 210.

The Video/Media Player 210 connects (arrow 216) to the Video Advertisement Harmonization Service 250, requesting from it to perform a video advertisement harmonization process or service. The Video/Media Player 210 also provides to the Video Advertisement Harmonization Service 250 the advertisement streaming document/dataset/digital record, that was generated by the Advertisement Exchange System 230, along with the video streaming details.

The Advertisement Harmonization Service 250 connects to the Video Provider System 220 to request the target video (arrow 252), and also requests the advertisement component (arrow 254) from the relevant Advertisement Provider System 240. The Advertisement Harmonization Service 250 analyzes the advertisement content and the target video, and provides (arrow 216) a new or updated advertisement streaming document content to the Video/Media Player 210.

The Video/Media Player 210 then parses the harmonized advertisement streaming document that it received from the Advertisement Harmonization Service 250, and requests the advertisement stream (arrow 216) from the Advertisement Harmonization Service 250. The Video/Media Player 210 then follows the instructions or data provided in the new/updated stream advertisement document, to smoothly insert the advertisement content into the target video, locally (client-side) by or at the Video/Media Player 210, during video playback and/or immediately prior to video playback, in real-time or in near-real-time.

Additionally or alternatively, another flow of operations can be used to automatically add product advertisement content/image(s) to specific video frames of the target video. For example, the Video/Media Player 210 connects to the Video Provider System 220, requesting (arrow 212) a target video stream. The Video/Media Player 210 connects also to the Advertisement Exchange System 230, requesting (arrow 214) image(s) of advertisement product(s) for in-video placement. The Advertisement Exchange System 230 connects (arrow 232) to one or more Advertisement Provider Systems 240, and selects one or more images of advertisement products for in-video placement. The Advertisement Exchange System 230 generates a document or dataset or other digital record that represents or indicates the streaming details of the advertisement's media. and delivers it (arrow 214) back to the Video/Media Player 210. Then, the Video/Media Player 210 connects (arrow 216) to the Advertisement Harmonization Service 250, requesting an advertisement harmonization service or process. The Video/Media Player 210 delivers the advertisement streaming document or digital record that was generated by the Advertisement Exchange System 230, along with the target video streaming details. The Advertisement Harmonization Service 250 connects to the Video Provider System 220 to request the target video (arrow 252), and also requests the advertisement product(s) (arrow 254) from the relevant Advertisement Provider System(s) 240. The Advertisement Harmonization Service 250 then analyzes the target video in order to smoothly and seamlessly place and/or fit and/or insert the advertisement product(s) into specific video frames of the target video; and provides (arrow 216) a new/updated video streaming document to the Video/Media Player 210. Then, the Video/Media Player parses the harmonized video streaming document, and requests the relevant video stream (arrow 216) from the Advertisement Harmonization Service 250; and the Video/Media Player 210 can then playback the new content that includes the in-video placement/insertion of the advertisement product(s).

Reference is made to FIG. 3, which is a flow-chart of a method of video advertisement harmonization, in accordance with some demonstrative embodiments. For example, a set of rules and/or parameters defines the video advertisement harmonization process, and is configured or set block 320. The core processing of the harmonization is shown in block 340; it provides a harmonized advertisement that better fits or smoothly fits or seamlessly fits into the advertisement viewing temporal time-segment of the specific target video, and/or generates the product(s) advertisement(s) spatially embedded into the relevant video-frames. In some embodiments, such as in the server-side implementation of FIG. 2, the resulting output is further prepared for streaming in block 360. Once the output is ready, the Video/Media Player is notified (block 380), and the Video/Media Player can then request the modified harmonized advertisement stream.

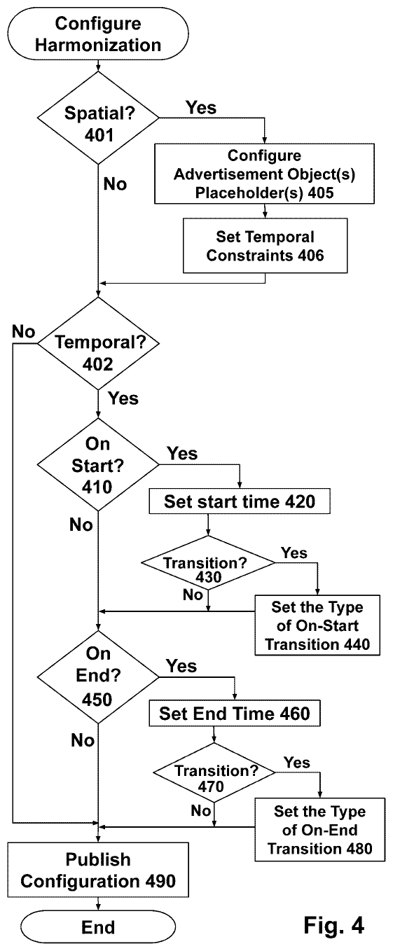

Reference is made to FIG. 4, which is a flow-chart of a method of configuration of video advertisement harmonization, in accordance with some demonstrative embodiments.

As shown, the method checks whether the requested/required/relevant harmonization would be Spatial (block 401) and/or Temporal (block 402). For example, if the input is an advertisement video component then temporal insertion and harmonization is performed; whereas, if the input is an image of a product intended for in-video placement then spatial insertion of that product-image into particular video-frames is performed.

In the Spatial insertion and harmonization mode, placeholders are configured or set (block 405) for the in-frame placement of the advertisement content (image/s); and temporal constraints are set or configured (block 406; such as, by determining which particular time-slots or video-frames would be subject to the in-frame adding of the advertising content image/s).

In the Temporal insertion and harmonization mode, the method checks (block 410) whether harmonization is requested/required “on start”, namely, at the start of the advertisement video segment that is inserted into the target video. If yes, then: the method sets or selects the particular time-point of the target video at which the advertisement video segment would start (block 420), or the method selects or uses a pre-defined advertisement insertion start time (e.g., some target videos may be accompanied with a record indicating suitable/preferred time-points for such temporal insertion). If a harmonized “on start” transition is requested/required at the start of the advertisement video segment (block 430), then the type of on-start transition is selected or set (block 440), such as from a pool of available on-start transitions or transition effects.

Similarly, the method checks (block 450) whether harmonization is requested/required “on end”, namely, at the end of the advertisement video segment that is inserted into the target video. If yes, then: the method sets or selects the particular time-point at which the advertisement video segment would end (block 460), such as by obtaining the time-point of the next frame of the target video (which would reflect that end of the advertisement on the video timeline). If a harmonized “on end” transition is requested/required at the end of the advertisement video segment (block 470), then the type of on-end transition is selected or set (block 480), such as from a pool of available on-end transitions or transition effects.

The method then publishes or transfers or sends the determined configuration (490) to one or more other components of the system, or to one or more other modules that perform the harmonization process.

Referring now back to block 405, in some embodiments, the minimum requirements can be to define the advertisement product image/s placeholder/s as “Add” or “Replace”; such that an advertisement product image can either be added to the relevant video-frame(s), or can replace another in-video object that already exists in the video.

Some embodiments may support or utilize manual configuration of the advertisements'product placeholders; such that for each advertisement product, a user would provide a placeholder tag, to be searched for, on the video.

Additionally or alternatively, some embodiments may support or utilize automatic or semi-automatic configuration/detection/determination of the advertisements'product placeholders. For an “Add” type of insertion, the process searches via Computerized Vision and/or using a large Vision-and-Language Model (VLM) or a Large Multi-Modalities Model (LMM or LMMM) for a suitable object in the video to which each advertisement product image can be added (e.g., searching for a table in the video in order to place an advertisement image of a soda bottle on such table). For a “Replace” type of insertion, the process searches for a suitable object in the video that can be replaced by an advertisement product image (e.g., searching the video for an already-existing shirt, in order to replace it with an advertising product image of another shirt). The automatic process may optionally detect several candidate placeholders. In some embodiments, the process may switch automatically from “Replace” to “Add”, if no objects suitable for replacement were found; or, the process may switch automatically from “Add” to “Replace” if no objects suitable to accommodate addition were found and only suitable objects for replacement were found; other suitable rules or conditions may be used to enable automatic operation, or to automatically switch or select to Add or to Replace, taking into account the automatically-found (or not found) placeholder candidates for such Add-type insertion or Replace-type insertion.

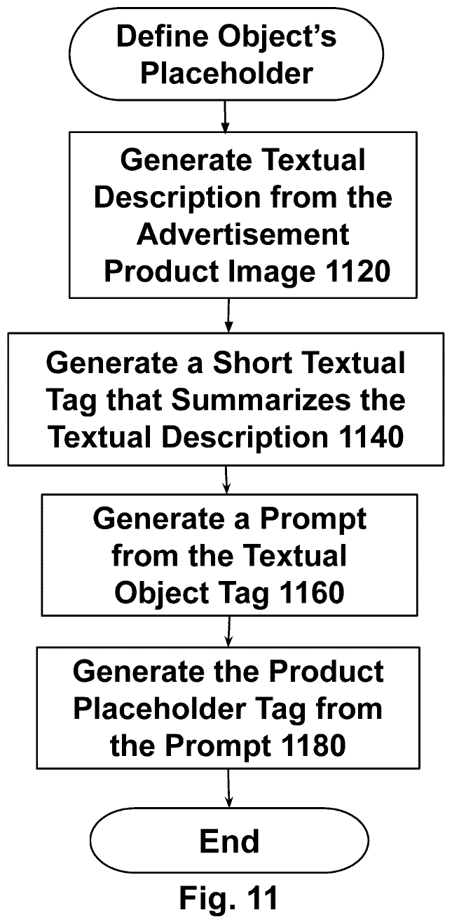

Reference is made to FIG. 11, which is a flow-chart demonstrating defining placeholder(s) for object(s), and/or performing detection loops to automatically detect candidate placeholders pertaining to each product of advertisement content, and/or automatically determining (using VLM and/or LLM and/or LMMM and/or other AI models) relevant context and generating a suitable Object Placeholder Tag, in accordance with some demonstrative embodiments.

For example, a textual image description is generated (block 1120), by feeding the advertisement product image (or other media content) into a large Vision-and-Language Model (VLM) or a Large Multi-Modalities Model (LMMM or LMM), and prompting that model to generate and output a textual description of the advertisement product that is depicted in the image.

Then, the VLM or LMMM, or a Large Language Model (LLM) is utilized to automatically generate a single textual tag (block 1140) that summarizes that textual object description. For example, this step summarizes the textual description of the image, that was generated in block 1120, into a short textual tag or a short textual string; such as, into a one-word textual object tag (e.g., “bottle” or “table”), or into a two-word textual object tag (e.g., “soda bottle” or “round table”), or in some implementations into a three-word textual object tag (e.g., glass soda bottle” or “round wooden table”). It is clarified that in some embodiments, an LLM can suffice for these operations, of summarizing a longer text into a shorter textual tag; however, some implementations may utilize a VLM or an LMMM for this purpose as those units can also summarize text and generate text.

Then, the LLM utilizes that single textual tag that corresponds to a summarized image description, to generate and formalize a prompt requesting generation of a placeholder object tag (block 1160).

Finally, the prompt that was generated is fed into the LLM or into a VLM or LMMM, which generates one or more candidates of a suitable placeholder tag (block 1180), that later are analyzed by the VLM or LMMM to find of those candidates exist in the actual video frames (or the actual image) into which the product would be inserted.

It is noted that the LLM receives as input a prompt that is configured according to each advertisement product mode, namely “Add” or “Replace”.

For example, if the mode is “Add”, then the prompt would request to suggest “objects tags” that can be used as placeholders for a product description. For instance, the advertisement product may be a bottle of wine; and the number of placeholders can be 10; and the prompt may be or may include: “As a computer vision expert, suggest 10 object tags that can be used as a location to put a bottle of wine on it or in it”. The LLM generates output such as: Dining Table, Kitchen Counter, Bar Counter, Bookshelf, Coffee Table, Picnic Table, Sideboard, Mantelpiece, Outdoor Patio Table, Cabinet Shelf.

In contrast, if the mode is “Replace”, then the prompt would request to suggest “objects tags” that can be used as placeholders according to the result of the textual product description of the advertisement product. For instance, if the advertisement product is a bottle of wine, and the number of placeholders is 10, then the prompt may be or may include: “As a computerized vision expert, I would like your help to replace an already-existing object with a ‘bottle of wine”, so please suggest 10 object tags that can be used as candidates to search for”. The LLM may generate an output of: Water Bottle, Juice Bottle, Beer Bottle, Olive Oil Bottle, Vase, Liquor Bottle, Champagne Bottle, Perfume Bottle, Milk Carton, Soda Can.

The LLM-generated output of the placeholder configuration is saved per advertisement product, as part of the publish configuration (block 490) and is used by the processing module (block 510).

The advertisement product Add/Replace video harmonization can operate in conjunction with video advertisement temporal insertion. For example, the operations of block 406 define or determine or configure a set of constraints on the video timeline. As non-limiting examples, such constraints may include: (i) Avoid time-segments or time-slots in the target video, such as, do not perform temporal insertion in the initial 15 percent of the time-length of the video, or in the final 10 percent of the time-length of the video); (ii) another constraint such as, “Avoid a particular time segment or time-slot of the original video when performing temporal advertisement insertion” (e.g., the time segment from 24 seconds into the original video until 37 seconds into the original video should Not be subject to spatial adding of advertisement content and/or to spatial replacing of content).

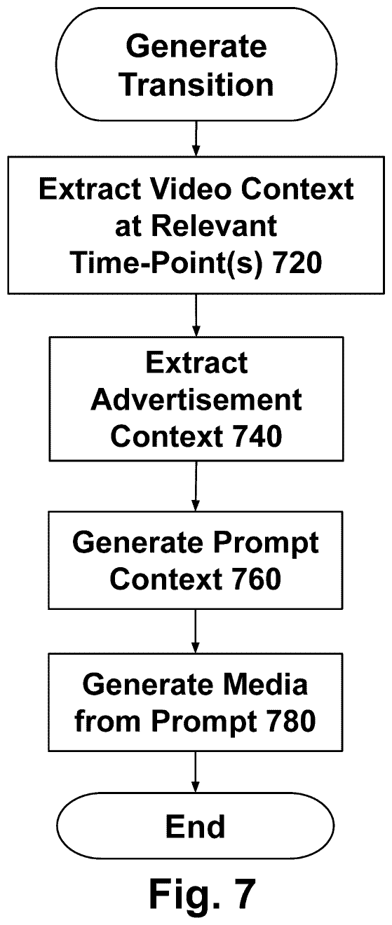

In a demonstrative example, a common use case is harmonizing the entire advertisement so it would better fit the video. Some advertisement providers or vendors may restrict or constrain the harmonization. This can be mitigated by adding a transition from the video to the advertisement, and/or from the advertisement back to the video. The transition may be (as non-limiting examples) a smooth video transition, such as fade in, fade out, dissolve, or the like. Another option for a transition can be adding a generated media which tailors the “story” between the video content and the advertisement content, as demonstrated herein with reference to FIG. 7, or by adding other type of machine-generated or automatically-generated or AI-generated media transition.

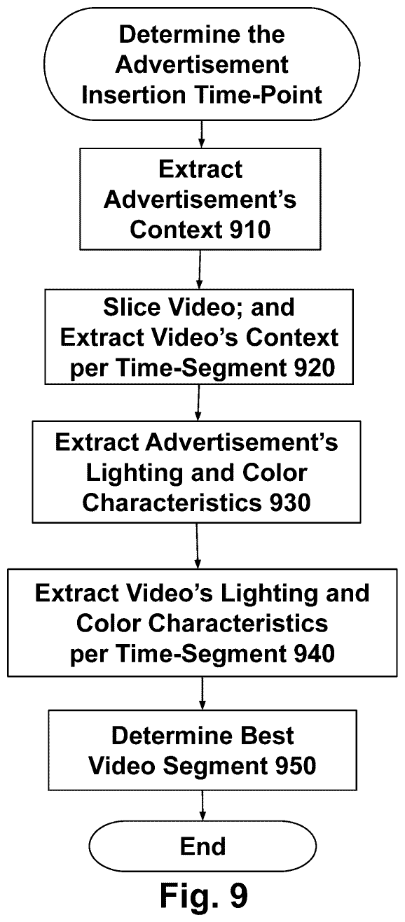

The advertisement insertion time is commonly pre-defined, but can be also harmonized by finding the optimal point with relation to context or visuals, as demonstrated herein with reference to FIG. 9.

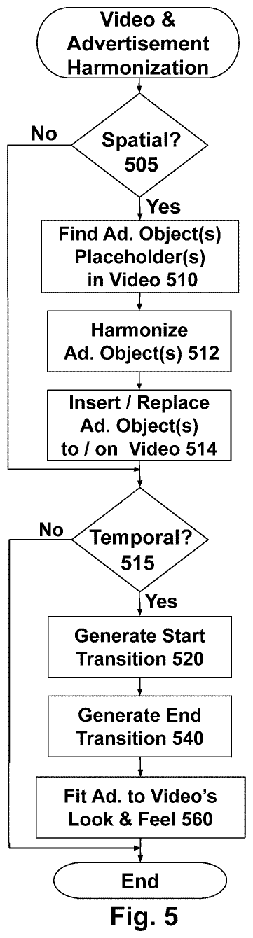

Reference is made to FIG. 5, which is a flow-chart demonstrating in greater detail the harmonization process (e.g., of block 340), in accordance with some demonstrative embodiments.

For example, if Spatial processing is required (block 505), then: the process finds advertisement objects placeholders in video (block 510); performs he harmonization of each advertisement object (block 512); and performs the insertion/replacement of the advertisement objects based on the placeholder(s) (block 514).

Additionally or alternatively, if Temporal processing is required (bock 515), then: the process generates a start transition from the video to the advertisement (block 520); the process generates an end transition from the advertisement back to the video (block 540); and the process performs the harmonization of the start transition to the advertisement and then the end transition back to the video (block 560), and/or performs the harmonization of the advertisement content itself as well as the starting transition and the ending transition, taking into account the look-and-feel of the target video as part of the harmonization operations.

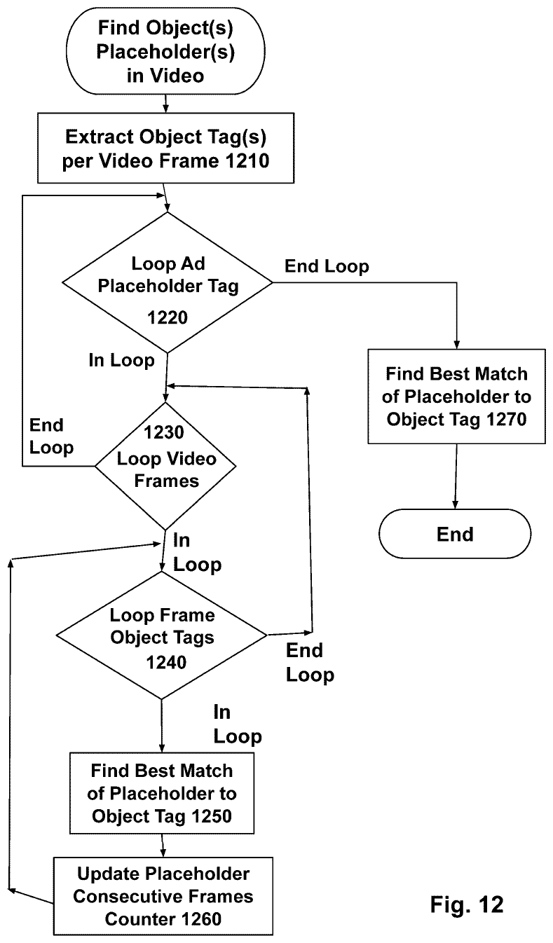

In the Spatial insertion (block 510), one or more processes may be used. As a non-limiting example, the process may find objects'placeholders as described with reference to FIG. 12.

Reference is made to FIG. 12, which is a flow-chart demonstrating detection or finding or determination of object placeholder(s) in a video, in accordance with some demonstrative embodiments.

For example, a VLM or LMMM can be used for directly performing object tagging in video frames; or, some embodiments may use an image object tagging AI-based model wherein each video frame represents an image; or some embodiments may a partial temporal video-segment for such AI-based object tagging, which can be a layer in the trained AI model. The result of the video object tagging operations is a list of object tags per video frame.

The resulting video object tags are compared to the input placeholders list, to find a matching candidate. There can be multiple matches, and the process is configured to find the most suitable match or the best match to the advertisement product. This can be achieved using an LLM (which can suffice) or VLM or LMMM (e.g., in block 1250) that is prompted to analyze and understand the context of the object tags and to provide a single answer corresponding to the selection of the best match out of several candidate matches. For example, the LLM or VLM or LMMM may determine that for the advertisement object “bottle of soda”, having three candidate placeholders of “bookshelf” and “floor” and “kitchen table”, the placeholder of “kitchen table” is the most suitable for placement of that product, based on the general knowledge-base on which the LLM/VLM/LMMM was trained. An automated operation selecting Add or Replace operations can be defined or configured in some embodiments, to implement a decision method according to the matching result. In some embodiments, optionally, the process may try both operations (Add and Replace), and then decide based on the estimated quality of each operation result, which is more suitable for the specific advertisement product and for the specific target video.

As demonstrated in FIG. 12, the process loops on all the advertisement object placeholder tags (block 1220). While the loop is performed for each such advertisement object placeholder tag, the process loops on all the video frames (block 1230); and while the loop is performed for each such video frame, frame object tags are looped (block 1240) with regard to the object tags extracted in block 1210 per each video frame of block 1230; and each such video frame (or, in some embodiments, a batch or set of consecutive video frames) is searched to find the best match of object placeholder to object tag (block 1250), with an update to a counter (block 1260) or monitoring parameter for consecutive video frames that are associated with the same placeholder. In some embodiments, for example, the operations may generate a match score that is further processed as described herein, and the process ensures that the search for the best placeholder is not necessarily performed on a frame-by-frame basis, but rather on the basis of a set or batch of at least N consecutive frames (e.g., at least 30 consecutive frames, that correspond to one second of video in a 30 frames-per-second video), to prevent a situation in which a set of 5 video frames is selected but corresponds to a time-duration that is too short to effectively show the advertisement product. The looping processes end and yield the best match that was found for the placeholder to the object tag (block 1270). For example, the operations of blocks 1250 and 1260 generate a match score per frame object tag (from block 1210) that relates to product tag (from block 1220); and the operations of block 1270 select the highest match score after processing all the product tags for all the frames for all the objects per video frame.

In some embodiments, another feature or layer can improve or maximize the temporal appearance of the advertisement object. For example, the process can be configured to select an object in the video that has the maximum number of continuous/consecutive frames (block 1270), to ensure a sufficiently-long video-segment that can accommodate the advertisement product insertion. This can be implemented as a filter on all the detected objects per video frame across all video frames; or, it can be implemented on the outputs of the LLM/VLM/LMMM which may require greater computing resources but may have higher quality due to the extended context. This additional layer may further take in account non-continuous/non-consecutive video frames, such as by using temporal averaging that optionally ignores missed detections on single or isolated frames, and the monitoring and frame-counting of block 1260 can be configured for this purpose. For example, the operations of block 1210 extract object tags per video frame and define the relevant boundaries of a bounding box or segmented bitmap corresponding to the scope of the object tag; and once a placeholder is selected in block 1270, the relevant object boundaries of that placeholders are the output of block 510. Accordingly, the output of block 510 can thus be a list of object coordinates, such as the boundaries or scope of a bounding box, or an exact object segmentation which can be saved per video frame or (in some implementations) per group-of-frames or for a batch of consecutive frames.

Referring back to FIG. 5, the operations of block 512 are configured to harmonize the advertisement object that is intended to be inserted into the video (via Add or Replace). Similar to the operations of block 820 described herein, the video frame lighting and color characteristics are extracted. These characteristics are used for the advertisement product color correction and grading, similar to the operations described herein for blocks 840 and 860]. The color corrections and color grading may be done globally referencing the video frame, or locally using spatial characteristics of the bounding box coordinates.

The operations of block 514 add the advertisement product into the video, on a per-video-frame basis, at the placeholder location; and/or it replaces an existing object(s) in the video with the advertisement product, again per video frame. It is noted that in some embodiments, the Replace process may replace two (or more) existing objects in the target video, with a single advertisement product; for example, replacing an existing set of salt and pepper on a kitchen table, with an advertisement image of a single soda bottle. Similarly, additionally or alternatively, the Replace process may replace one existing object in the target video, with two or more separate or discrete advertisement products; for example, replacing a single bottle of soda on a kitchen table, with three small boxes of cookies.

In some embodiments, the process of Adding advertisement product object(s) can be performed as follows. First, the process calculates or determines the size of the detected placeholder relative to the video frame. Then, the process automatically re-sizes the object to fit the relative placeholder size; such as, using a VLM or LMMM that can resize and/or cluster objects to different sizes according to the placeholder size. Such VLM or LMMM or an LLM may be fed a prompt such as, for example, “As a computer vision expert, please suggest a resolution for an object to be added onto a table of size 500×300 pixels, based on an image of size 1,280×720 pixels”. Then, the process proceeds to place the resized and harmonized advertisement product at the center of the placeholder. Optionally, some embodiments may further improve or fine-tune the placement using perspective analysis and/or depth calculation.

Similarly, the process for Replacing a video object with an advertisement product object may be performed as follows. Firstly, the process performs Resizing of the advertisement product according to the placeholder size, taking into account the total size of the video frame. Then, the process removes the placeholder object from the video frame, such as using an AI-based inpainting method (e.g., using Stable Diffusion or similar AI-based tools) and/or using a deterministic algorithm similar to a “magic eraser” algorithm that can remove a particular object from an image. Then, the resized and harmonized advertisement product is added into the video frame.

The above operations of Add or Replace are repeated, for all the advertisement products across scoped video frames as configured or defined in block 406.

In some embodiments, during video time segments in which advertisement products were synthetically added, the process may be configured to automatically add a logo or a label or a title or other visual/textual indicator to the video frames (or to some of them), signaling or indicating to the viewer that this video-portion was altered using AI-based tools; and this can be performed at the end of block 514, in order to comply with regulatory requirements or in order to voluntarily provide full disclosure to the viewer.

Referring now back to the Temporal insertion, the operations of blocks 520 and 540 can use the configuration parameters from block 490. The process may optionally skip the adding of a transition effect, selecting only the start and/or end video time for harmonizing the advertisement (block 560). Another option, in some implementations, is to use a pre-define transition effect (e.g., fade in, fade out) which is tailored at the start and/or the ending of the advertisement segment with the defined video time.

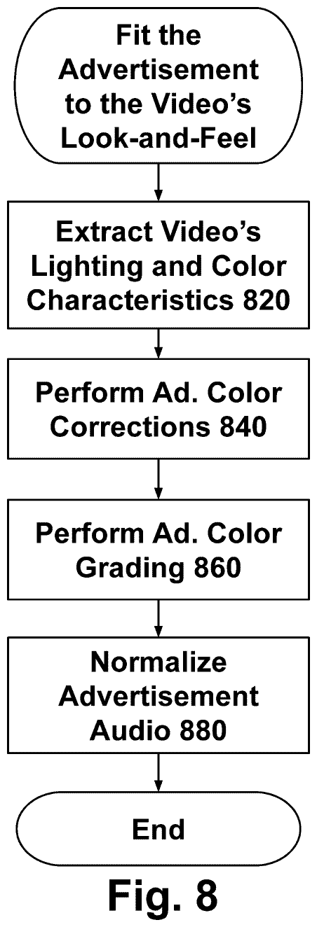

In some embodiments, AI-generated media (video and/or audio) can be used, and such process can be configured in block 490; and a start transition and/or an end transition can be generated as described herein with reference to FIG. 7. The resulting transitions are concatenated to the advertisement (block 560) and are then further processed in accordance with the flow of FIG. 8 described herein.

In accordance with some embodiments, the video ad harmonization service (e.g., of block 250) may utilize a video streaming service, in order to stream the result of processed harmonized advertisement to the client-side media/video player. Block 360 prepares for streaming the resulting harmonized advertisement video with the added and/or replaced advertisement product(s) for streaming.

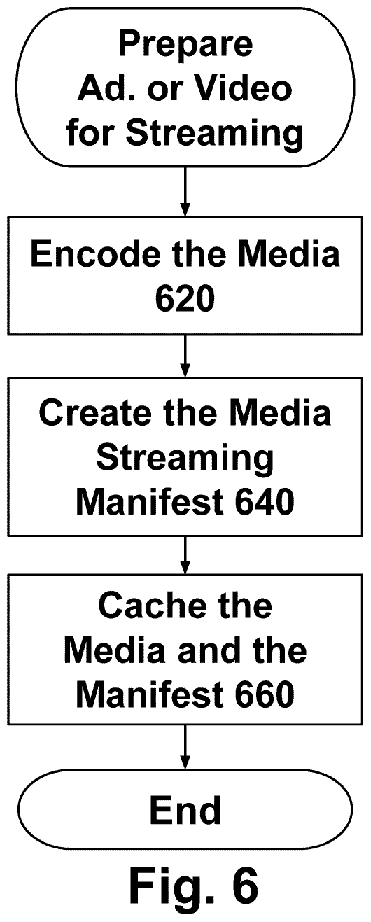

Reference is made to FIG. 6, which is a flow-chart demonstrating the preparation of such video for streaming, in accordance with some demonstrative embodiments.

Firstly, the media is encoded (block 620) using a suitable video codec and audio codec; such as H.264/AVC or H.265/HEVC or VP9 or Av1 for video, or such as AAC or AC3 or Vorbis or MP3 for audio. The encoding may optionally include support for adaptive bit-rate, encoding the advertisement into chunks. Then, a streaming manifest document is created (block 640), including the media details. The process then performs caching [block 660] of the outputs from blocks 620 and 640, namely the media and the manifest; optionally supporting geo-location and rapid distribution via a Content Delivery Network (CDN), enabling a plurality of different users to view the same video with the same advertisement content added/inserted therein.

Reference is made to FIG. 7, which is a flow-chart demonstrating the utilization of Generative AI to create transitioning scenes or transitioning effects, from the target video the advertisement content and/or from the advertisement content back to the target video, in accordance with some demonstrative embodiments.

For example, a VLM or LMMM can be used to deduce or extract or estimate the context of the target video (e.g., or the particular context of a particular segment of that target video), as indicated in block 720; and also the context of the advertisement content (block 740).

In a demonstrative implementation, scene change detection is performed, dividing the media into segments. Then, selected video frames per scene are extracted; such as, extract a video frame out of every N frames (e.g., N being 15 or 30), or every T milli-seconds (e.g., T being 250 or 500) to reduce computation costs and processing resources consumption. The analysis may further determine whether the video may require a shorter time-segment before and after the advertisement insertion time; and whether the advertisement content would require its entire duration or only a portion thereof. In some embodiments, video frames are firstly extracted and converted into discrete images for VLM or LMMM analysis; or, video frames can be directly analyzed by such VLM or LMMM; or, an advanced VLM or LMMM can be configured to generate context information automatically from an entire video or video-segment without performing frame extraction or without performing analysis on a frame basis.

Video context processing is then performed. For example, the process can request and generate a textual description of each image/frame/scene using, LLM or VLM or LMMM or other AI-based engine. All the textual descriptions of the video are combined into a textual video collection (block 720); and similarly, all the advertisement textual descriptions are combined into a textual advertisement collection (block 740).

The process then obtains from an LLM (or VLM, or LMMM) a short summary describing the context of the textual video collection; and similarly, the process obtains from the LLM (or VLM, or LMMM) a short summary describing the context of the textual advertisement collection.

In some embodiments, the method further performs processing of audio context, or extraction of audio-based context. For example, the process may automatically generate a textual transcript from the audio track of video and from the audio track of the advertisement content; and the LLM (or VLM, or LMMM) can be invoked to automatically generated a short textual summary describing the context of the transcript relative to the video and to the advertisement content.

Some embodiments may generate a combined audio-and-video context; such as, by merging the textual video description with the audio transcription, and commanding the LLM (or VLM, or LMMM) to generate a short textual summary describing the context of the merged collection for the video and for the advertisement content.

The process then proceeds to generate the relevant prompt (block 760), based on the video textual context and the advertisement textual context; thereby generating a textual for a Gen-AI/Generative-AI tool that can generate synthetic video and audio. In some embodiments, the prompt generation can be automatically generated using the LLM or other AI-based tool that is specifically invoked for this.

In some embodiments, for example, a template-based prompt is fed into the LLM to generate the prompt. A first prompt-segment defines the expertise to the LLM, such as, “You are a prompt engineering expert that specializes in generating textual prompts for generating multimedia content for the advertisement market”. Another prompt-segment defines the particular task; such as, “Please generate a textual prompt that will cause a Generative-AI engine to create a video transition from [Video-Context] to [Advertisement-Context]” (e.g., inserting the actual Video Context text and Advertising Context text in those brackets; or defining them in an additional prompt-segment), and/or “Please generate a textual prompt that will cause a Generative-AI engine to create an audio transition from [Video-Context] to [Advertisement-Context]”. Optionally, another prompt-segment can be added to define one or more constraints; for example, matching the duration for video and audio, positive requirements (e.g., “the resulting transition should be at least 0.5 seconds long”), negative requirements (e.g., “the resulting transition must not be longer than 1.75 seconds long”, or “the resulting transition must not be a fade-out effect”). In some embodiments, optionally, a pre-defined or manually-curated pool or bank or dataset of prompt-segments (or constraints, or conditions) can be prepared in advance, optionally having dozens or even hundreds of such items; from which the LLM can select several prompt-segments in order to generate the textual prompt. In other embodiments, the LLM can be commanded to generate not-previously-defined textual prompt-segments, based on the LLM's “understanding” of the relation between the video context and the advertisement content context.

Finally, the Generative-AI engine is invoked and is fed the LLM-generated textual prompt, to generate the synthetic transition media (video and audio), as indicated in block 780; which can be the transition from the video to the advertisement content (block 520), or the transition from the advertisement back to the video (block 540).

In some embodiments, the generative media AI-based engine may use a first dedicated model for generative video and a second generative model for generative audio (speech and/or music). The video and audio are then packaged together to generate the full transition audio-and-video. The process of block 560 then operates to package together the results from block 520 and 540 with the advertisement content, to generate the extended and harmonized advertisement audio-and-video segment for temporal insertion to the target video.

Reference is made to FIG. 8, which is a flow-chart demonstrating fitting or harmonizing the look-and-feel of the advertisement content, to better match the look-and-feel of the target video, in accordance with some demonstrative embodiments. These operations are further reflected in block 560 mentioned above.

For example, the process extracts the look-and-feel characteristics of the video (block 820) which is reflected by the lighting and color characteristics. The video is built from video frames and utilizes temporal averaging of the characteristics. Optionally, additional information or meta-data may be extracted from the video stream headers. In accordance with some embodiments, the method extracts, separately, both (I) the look-and-feel/color/lighting characteristics of the target video, and also, (II) the look-and-feel/color/lighting characteristics of the advertisement content that is intended for insertion or placement; in order to take these extracted attributes into account in the harmonization process and in the operations of blocks 840 and 860.

In a demonstrative implementation, the calculations may include: (a) Converting the video into separated luminance and color planes; as video is commonly encoded with already separate luminance and color planes using YCbCr color format, or using other color formats (e.g., HSV or Lab). (b) Calculating per frame, or on a frame-by-frame basis, the mean and standard deviation for each color plane. (c) Calculating the white balance using averaged white content, on a frame-by-frame basis or for a group-of-frames. (d) Calculating contrast using histogram, on a frame-by-frame basis or for a group-of-frames. (e) Temporal averaging of each parameter values, such as per color plane.

The process may also extract and utilize stream information or meta-data; such as: bit color-depth; color primaries; color transfer; color space; color range; High Dynamic Range (HDR) metadata; and/or other parameters or meta-data.

The process then performs color correction (block 840) on the advertisement media, according to the data extracted from the video in the previous operations. The color correction may include, for example: (a) Matching the advertisement stream information to the video information using conversion to linear space and tone mapping to match the video characteristics. (b) Normalizing the advertisement white balance according to the video white balance, such that both would have the same white appearance. (c) Normalizing the advertisement contrast to match the video contrast using as an example histogram matching or color transfer technique on the luminance plane.

The process then performs color grading (block 860) on the advertisement media, such that it would better match the color grade of the target video. This may be performed using color transfer techniques based on the color distribution of the target video; for instance, as non-limiting examples by normalizing the mean and standard deviation of the advertisement color planes to match the mean and standard deviation of the target video; and/or by using a pre-defined look-up table on the advertisement to match the color grading of the target video.

The process further performs harmonization of the audio of the advertisement content (block 880), such as by normalizing it according to the audio track of the target video. This may include, as non-limiting examples: (a) aligning or matching or modifying audio parameters, such as sample rate, number of channels, or other audio parameters; (b) normalizing the gain reflected as peak level or loudness, such as according to loudness normalization EBU R-128; (c) performing noise-reduction operations on the audio track of the advertisement content, such as, in order to match a generally-calm and noise-free audio track of the target video; (d) modifying or increasing or decreasing the volume level of the audio track of the advertisement content, such as, in order to match the audio level of the target video; (e) optionally, adding a particular sound effect into the audio track of the advertisement content, to match an ongoing or repeating or existing sound effect that was automatically recognized in the target video (e.g., the target video depicts an outdoor scene in the rain, with rain sound effects continuously accompanying the target video; and therefore, the process can automatically add rain sound effects as background/ambient sounds to the audio track of the advertisement content). Other audio modifications can be automatically determined, invoked and performed, to further harmonize the audio track of the advertisement content to the audio track of the target video.

Reference is made to FIG. 9, which is a flow-chart demonstrating automatic determination or automatic finding of a most-suitable time-point, in the target video, at which the advertisement video would be temporally inserted, in accordance with some demonstrative embodiments. This can be performed if the target video does not provide a pre-defined/pre-indicated time-point that was designated as being suitable for such temporal insertion.

As demonstrated in block 910, textual context information is generated for the advertisement content (e.g., as described with reference to block 720 above).

The target video is automatically sliced or divided into video-segments (block 920), taking into account (for example) scene changes, audio changes, abrupt visual changes, abrupt audible changes, audio silence, beginning and ending of speech, beginning and ending of music or sound effects, sudden or abrupt change in visual scenery, or the like. The slicing can be performed using deterministic algorithms and/or rules, or using a VLM or LMMM that analyzes the target video and proposes time-points for such slicing.

The process then extracts (block 920) textual context information for each video-segment that were prepared in the slicing stage (e.g., based on the operations described for block 720); optionally skipping the first and/or the last video-segment as they can be defined (in some implementations) as non-desired or non-suitable candidates for temporal advertisement insertion.

The process further extracts the look-and-feel characteristics of the advertisement content, in block 930; such as, by using the operations described for block 820.

The process then extracts the look-and-feel characteristic of each video-segment, in block 940; such as, by using the operations described for block 820.

The process iterates over all the video-segments, such as by performing: (a) Calculating the distance of look-and-feel characteristics between a video-segment and the advertisement content, such as, based on average mean and standard deviation per color plane; (b) Using the LLM or VLM or LMMM to calculate a distance for the embedding result context; (c) Calculating the weighted average of the distances of context and look-and-feel characteristics.

The process then selects the particular video-segment that has the minimum distance parameter(s) relative to the corresponding parameter values of the advertisement content (block 950). In accordance with some embodiments, the time-point of the beginning of the selected video-segment is then used as the time-point for insertion of the advertisement content. In other embodiments, the time-point of the ending of the selected video-segment is used as the time-point for insertion of the advertisement content.

Reference is made to FIG. 10, which is a schematic block-diagram illustration of a system 1000 for video advertisement insertion and harmonization, in accordance with some demonstrative embodiments. System 1000 may be implemented using suitable hardware components and/or software components.

For example, Harmonization Module 1010 may be implemented using a Central Processing Unit (CPU) 1020; and/or a Harmonization Module 1030 may be implemented using a Graphics Processing Unit (1040). Each component may be associated with a memory unit for temporarily storing data; and a long-term Storage Unit 1050 is used to store long-term data, such as input media, output media, AI models, and other information. A network 1060, such as wireless or wired or Internet-based, is used for communications among components of the system (e.g., operations described with reference to block 216, block 252, block 254).

The system may be implemented using a locally-running and/or a remote or cloud-based VLM and/or LLM and/or LMMM, or other AI-based models or engines.

In some embodiments, the system may perform both spatial insertion and temporal insertion of a product, or of two or more products, into a single target video. In a first non-limiting example, the system receives a target video having a length of 10 minutes; and an advertisement video or an advertisement animation (e.g., an MP4 file with a five-seconds video or with 150 video-frames, or an Animated GIF file) that depicts a hot bowl of soup with steam or “smoke” swirling in the air over the hot soup. The system may determine to perform temporal insertion of the video of the hot bowl of soup, at a particular time point (e.g., at 1:37 minutes into the target video), such that the five-second video of the steamy soup bowl will appear at that time-point, with harmonized on-start transition and/or on-end transition.

Additionally or alternatively, the system may detect that in a particular scene of the target video, such as in a 20-second scene that begins at 5:00 minutes into the target video, there is depicted an empty kitchen table next to a talking person; and the system may automatically determine to perform spatial in-frame insertion of the steamy bowl of soup, in its animated/changing version, possibly in a resized version, into video-frames out of that 20-second video-segment that is visually suitable for such insertion. In some embodiments, the video-segment that has the empty kitchen table is 20-second long, whereas the animated/video segment of the steamy soup is only 5-second long; the system may determine that it would not be suitable to display the steamy soup for only five seconds and then to make it “disappear” from the table in the remaining 15 seconds in which that kitchen table is shown in the target video; or the system may firstly generate a 20-second looping segment that loops four times the original five-second video of steamy soup, and may then insert the product image (the steamy bowl of soup) from that 20-second looped video segment into the respective location or placeholder (on the empty kitchen table) in the particular video-frames of that segment of the target video, on a frame-by-frame basis.

Some embodiments perform temporal insertion of video advertisement into a target video, with temporal harmonization features that may include: (a) automatically harmonizing advertisement content look-and-feel characteristics according to those of the target video (and its audio track); (b) automatically harmonizing advertisement content by adding suitable video transitions and/or audio transitions, from the target video to the advertisement content, and/or from the advertisement content back to the target video; (c) automatically harmonizing advertisement content insertion by synthetically generating (e.g., using Generative AI) transition(s) content, from the target video to the advertisement content, and/or from the advertisement content back to the target video: (d) automatically detecting or finding or selecting the best or optimal or time-point of the target video for automatic insertion of the harmonized advertisement content there, according to video and audio context and according to matching (or, less distant) look-and-feel characteristics; (e) automatically harmonizing advertisement content using server-side processes, optionally in accordance with a pre-defined flow that is utilized by remote server(s) and/or by various client-and-server systems.

Some embodiments perform spatial in-video/in-frame insertion of video advertisement into a target video, with spatial harmonization features that may include: (a) automatic selection between, and automatic performance of, Add operations or Replace operations, of one or more advertisement products or objects into the target video, based on automatic detection and selection of particular placeholders in particular video-frames and/or video-segments; (b) automatically harmonizing the advertisement content to fit or match the look-and-feel characteristics of the target video as a whole and/or of a particular video-segments thereof; (c) selecting or identifying or recognizing or detecting the best or most suitable already-existing objects or frame-regions in the target video, to which the advertisement product can be spatially added; (d) selecting or identifying or recognizing or detecting the best or most suitable already-existing objects or frame-regions in the target video, which the advertisement product can spatially replace; (e) performing one or more of such adding/replacing/selection operations, on a frame-by-frame basis of the target video, or on a group-of-frames basis of the target video; (f) detecting or determining product(s), for spatial insertion/addition/replacement per video-frame or per group of consecutive video frames, and automatically utilizing them as placeholders for spatial insertion/replacement of advertisement product(s); (g) automatic selection of “Add” or “Replace” type of advertisement product insertion, according to detected placeholders tags, and/or or according to other criteria or conditions, and/or by performing both operations to generate “draft versions” or “interim version” that are then automatically analyzed by a VLM or LMMM to determine which version is estimated to be more appealing to a human viewer (e.g., the version that lacks abrupt or sudden visual/audible changes; the version that features smoother or longer transition effects; or the like); (h) automatically maximizing the time-length of appearance of advertisement product(s) in the target video, taking into account the number of consecutive frames per each such appearance; (i) automatically adding a logo or label or title to video segments, signaling or indicating that advertisement products were synthetically added to the original video.

Some embodiments provide a method for harmonizing advertisement insertion of an advertisement content into a target video, while harmonizing the look-and-feel according to matching characteristics of the target video and the advertisement content. In some embodiments, the method includes extracting the look-and-feel characteristics of the target video; and applying color correction and color grading modifications to the advertisement media to match as much as possible those of the target video, and/or to make the look-and-feel parameters of the advertisement video less distant or least distant relative to the corresponding look-and-feel parameters of the target video. The method may further include adjusting, modifying and/or normalizing the audio track of the advertisement content, according to the audio track of the target video.

Some embodiments provide a method for harmonizing automatic insertion of multiple advertisement products into a target video. For example, the method includes: detecting product placeholders per video frame (or, per group of video frames); applying color correction and color grading to each advertisement product according to the relevant video frame; adding selected harmonized advertisement products to the matching or corresponding placeholder of the relevant video frame(s); replacing selected matching placeholder(s) of already-existing objects or frame-regions, with a harmonized advertisement product on the video frame; automatically adding a logo or label or title or other indicator to a video segment, signaling or indicating that advertisement product(s) were synthetically added to the video.

In some embodiments, the method includes one or more of the following features or operations: adding transitions on the advertisement insertion time, from the target video to the advertisement content, and/or from the advertisement content back to the target video; automatically generating content transition according to the context and look-and-feel of the advertisement content and the target video (and its audio track); generating a transcript from the audio tracks for generating context; implementing a color transfer from the target video to the advertisement content; normalizing the advertisement content's video and audio characteristics according to the video features and the audio tracks of the target video; automatic selection of the time-point in the target video, for the advertisement insertion; contextually slicing the target video into video-segments (based on visual content and/or audio content; rather than based on pre-defined time-length or size of each video segment), and finding the best video-segment in terms of context and look-and-feel for the advertisement insertion; providing a streaming service for streaming the harmonized advertisement content; implementing object tagging from information deduced by VLM-analysis of video frames; implementing mapping of advertisement product(s) to placeholder object tags; performing automatic selection between Add mode and Replace mode, for spatial insertion of an advertisement content into a video, according to the tag detection results and/or according to other conditions or criteria or mechanisms; normalizing and/or modifying the size of the advertisement product in accordance with the detected placeholder size; implementing automatic advertisement product placement into or onto a particular video-frame of the target video, or into or onto a particular batch or group of video-frames of the target video; invoking a VLM or an LMMM to analyze and to determine or estimate visual features and/or audio features, of the target video and/or of the advertisement content that is intended for insertion; invoking an LLM (or VLM, or LMMM) to generate and/or analyze textual information and/or textual context, with regard to the target video and/or with regard to the advertisement content that is intended for insertion, and utilizing such LLM-generated textual context information for decision-making in the automatic process of harmonized insertion of advertisement content into a target video.

Some embodiments provide a computerized method for temporal insertion of advertisement content into a video, comprising: analyzing the target video to detect scene changes and dividing the video into segments; generating textual descriptions for each video segment using a Vision-and-Language Model (VLM); extracting look-and-feel characteristics for each video segment; analyzing the advertisement content to generate a contextual match with the video segments; calculating a distance metric between the advertisement content and each video segment; selecting a video segment with the minimum distance metric for advertisement insertion; determining the exact time-point within the selected segment for the insertion; and performing temporal insertion of the advertisement content into the target video, and/or particularly inserting into the target video a harmonized version of the advertisement video that was subject to color correction and/or color grading and/or other modifications that are operable to increase the visual matching between the look-and-feel of the advertisement content and the look-and-feel of the target video, and/or adding an on-start transition effect, and/or adding an on-end transition effect.

Some embodiments provide a method for temporal advertisement harmonization, comprising: converting the video into luminance and color planes for each frame; optionally performing analysis operations and/or statistical operations on values of particular attributes or characteristics, such as calculating the mean and/or the standard deviation of visual characteristics or particular attributes per segment; generating an embedding for contextual analysis of the video; performing similar embedding analysis for the advertisement content; comparing the embeddings to generate a match score for each video segment; selecting the most contextually relevant segment for insertion based on the match score; inserting the advertisement content into the selected segment at a calculated optimal time-point.

Some embodiments provide a method for temporal insertion of an advertisement video into a target video, comprising: dividing the target video into (differing time-lengths, non-equal-time) video segments using scene detection algorithms; generating a visual summary for each segment; generating a textual summary for the advertisement content; calculating context similarity scores between the video segments and the advertisement; ranking video segments based on similarity scores; selecting the highest-ranked segment for advertisement insertion; applying an on-start visual transition effect to harmonize the insertion.

Some embodiments provide a method for optimizing advertisement insertion into a video, comprising: segmenting the video based on abrupt visual and audio changes; extracting visual characteristics from each segment; analyzing the advertisement content for complementary visual attributes; performing similarity scoring between the advertisement and video segments; choosing the segment with the most complementary attributes; calculating the time-point for insertion within the segment; generating an on-start and on-end transition for seamless integration.

Some embodiments provide a method for seamless temporal insertion of advertisements into video streams, comprising: identifying time intervals with minimal scene changes, and/or dividing or slicing the target video into video segments according to detection of scene changes; generating textual descriptions of these intervals using a VLM; extracting audio descriptors for both the video intervals and the advertisement content; generating contextual embeddings for comparison; selecting a time interval with the closest contextual match to the advertisement; inserting the advertisement content at the mid-point of the interval; applying audio harmonization to blend the advertisement seamlessly.

Some embodiments provide a method for inserting advertisement content temporally into videos, comprising: analyzing video frame sequences to identify visually uniform segments; generating embeddings for both the video segments and the advertisement using a VLM; calculating contextual similarity scores for each segment; ranking the segments based on their similarity scores; selecting the segment with the highest rank for advertisement insertion; determining an insertion point within the segment based on scene dynamics, such as determining not to insert a fast-paced advertisement video-clip into a slow-paced/slow-changing scene in the target video, or determining to insert a slow-paced advertisement video clip into a slow-paced/little-changing/mostly-conversation based video segment of the target video; generating a smooth fade-out effect from the advertisement back to the video.

Some embodiments provide a computerized method for spatial insertion of advertisement content into a video, comprising: analyzing video frames to detect objects using a Vision-and-Language Model (VLM); generating object tags for detected objects in the video frames; identifying suitable placeholders for advertisement insertion based on the object tags; selecting a placeholder that best matches the advertisement content; resizing the advertisement content to fit the dimensions of the selected placeholder; applying color correction to harmonize the advertisement with the surrounding frame; inserting the resized and harmonized advertisement content into the placeholder.

Some embodiments provide a method for spatially embedding advertisements into videos, comprising: segmenting the video into frames; analyzing each frame for potential advertisement placeholders; classifying the placeholders as “Add” or “Replace” types; selecting the most contextually appropriate placeholder for the advertisement; resizing the advertisement to match the dimensions of the placeholder; applying depth estimation to align the advertisement with the spatial perspective of the frame; inserting the advertisement content into the selected placeholder.

Some embodiments provide a method for spatial advertisement insertion into video frames, comprising: detecting objects in video frames using object detection models; assigning relevance scores to detected objects based on their suitability for advertisement placement; selecting an object with the highest relevance score as the placeholder; extracting the spatial dimensions of the selected object; resizing the advertisement to fit the placeholder's spatial dimensions; performing brightness and contrast adjustments to visually match the frame; replacing the selected object with the resized advertisement content.

Some embodiments provide a method for adding advertisements spatially into videos, comprising: analyzing video frames to detect and tag objects; identifying multiple potential placeholders for advertisements within the frames; ranking the placeholders based on their spatial compatibility or contextual compatibility with the advertisement content, or based on an analysis by a VLM or LMMM that determines that two objects or two items (or, an item and a background region) are compatible with each other or are a good match for mutual placement; such as, a soda bottle as an advertisement content is a good match relative to a table in the target video, but not relative to a carpet in the target video; selecting the highest-ranked placeholder for insertion; resizing the advertisement content to the size of the selected placeholder; applying local color grading to harmonize the advertisement with the frame region; overlaying the advertisement content onto the placeholder.

Some embodiments provide a method for spatially harmonizing advertisements in videos, comprising: detecting objects and generating tags for each object in video frames; comparing the visual characteristics of the detected objects with the advertisement content; selecting a detected object that most closely matches the advertisement content's context; resizing the advertisement to align with the selected object's dimensions; removing the selected object from the video frame using inpainting techniques; replacing the removed object with the resized advertisement content; performing final adjustments to ensure seamless integration of the advertisement.

Some embodiments provide a method for spatial insertion of advertisements into videos, comprising: analyzing the video for repetitive patterns or surfaces suitable for advertisement placement, such as to detect a large surface that corresponds to a table-top or to a kitchen counter on which a “soda bottle” advertisement content can be placed, or such as to detect a large surface such as a wall or a floor of a room on which a “lamp” advertisement content can be placed; tagging these patterns or surfaces as potential placeholders; selecting a placeholder based on its prominence within the frame; resizing the advertisement to match the placeholder's aspect ratio; adjusting the advertisement's color temperature to match the video frame; aligning the advertisement's perspective to the detected placeholder's orientation; inserting the adjusted advertisement content onto the placeholder.

Some embodiments provide a method for embedding advertisement content into video frames, comprising: detecting objects within video frames using an AI-based object detection model; generating spatial coordinates for detected objects; classifying the objects as replaceable or additive placeholders; selecting a placeholder object based on visual prominence and contextual relevance; resizing the advertisement to fit within the spatial boundaries of the selected placeholder; adjusting the advertisement's shadows and highlights to match the frame's lighting conditions; inserting the advertisement content into the selected placeholder while maintaining spatial coherence.

Some embodiments provide a method for replacing objects in video frames with advertisements, comprising: analyzing video frames for objects suitable for replacement; generating textual tags for detected objects using a Vision-and-Language Model (VLM); comparing the advertisement content with the detected objects to find the best contextual match; selecting an object for replacement based on similarity scores; resizing the advertisement content to the dimensions of the selected object; removing the object from the frame using AI-based removal techniques; inserting the resized advertisement content into the location of the removed object.

Some embodiments provide a method for spatial advertisement placement in video frames, comprising: dividing the video into frames for individual analysis and extracting video frames; detecting and tagging objects within the frames; identifying placeholders that can be augmented with advertisements; selecting a placeholder based on its spatial and contextual alignment with the advertisement; resizing the advertisement to fit the placeholder's dimensions; performing local color and texture blending to harmonize the advertisement with the frame; overlaying the advertisement content onto the placeholder while preserving frame aesthetics.

Some embodiments provide a method for spatially integrating advertisements into videos, comprising: analyzing video frames to detect static and dynamic objects, such as detecting that a Table or a Carpet are static objects that remain in the same place across an entire video or an entire video-segment, or conversely detecting that a Dog or a Fireplace are dynamic objects that change their appearance and/or their location across frames of the target video or a particular video-segment ; classifying detected objects based on their size, position, and/or visual context; selecting an object that offers the highest visibility (or, a visibility level that is estimated to be higher than a pre-defined threshold) for advertisement placement (e.g., preferring to place a Soda Bottle on top of a white clean table, and not on top of another table that is cluttered with objects or that has a checkered map); extracting the spatial dimensions and orientation of the selected object; resizing and adjusting the advertisement content to match the object's spatial characteristics; replacing or overlaying the object with the advertisement content; applying final harmonization adjustments to match the lighting and color grading of the frame.

Some embodiments provide a method for generating context-aware transitions for advertisements in videos, comprising: analyzing the audio track of the video to extract tonal and emotional characteristics; analyzing the advertisement content's audio to identify complementary tones and moods; such as, detecting via audio analysis that a particular video-segment of the target video has a high-paced/fast-beat music or audio track, and is therefore suitable for temporal insertion of an advertisement clip that similarly has a high-paced/fast-beat audio track; or detecting via audio analysis that a particular video-segment of the target video as a conversational audio track in which two people are talking to each other, and therefore determining that this video-segment, or its ending time-point, are suitable for insertion of an advertisement video clip that similarly has a person talking or two people talking; optionally, generating textual descriptions of the video and advertisement audio contexts using a Large Language Model to further identify matches based on contextual or textual analysis; creating and/or selecting a transition prompt based on the audio context match; optionally invoking a Generative AI engine to generate an audio transition effect; blending the transition effect into the video's audio track; applying the harmonized audio transition alongside the advertisement insertion.

Some embodiments provide a method for dynamically selecting advertisement content for video insertion, comprising: analyzing the target video to extract dominant themes and visual contexts; generating metadata tags representing the video's themes using a Vision-and-Language Model; retrieving multiple advertisement candidates with matching metadata tags; ranking the advertisement candidates based on their visual and contextual similarity scores; selecting the highest-ranking advertisement candidate; resizing and adjusting the selected advertisement to match the video frame characteristics; dynamically inserting the adjusted advertisement into the video.

Some embodiments may further provide user-tailor or viewer-tailored selection of video ads and harmonization thereof, in a method for optimizing video advertisement placement based on audience preferences, comprising: analyzing historical viewer data to identify visual and contextual preferences; extracting key characteristics from the target video that align with viewer preferences; generating potential insertion points within the video using a predictive model; filtering these points based on audience interest alignment; selecting an insertion point most likely to engage viewers; adjusting the advertisement to match the preferred visual and tonal characteristics; inserting the advertisement at the selected point while maintaining engagement.

Some embodiments provide a method for multi-advertisement integration into video content, comprising: analyzing the target video to detect potential insertion regions; tagging these regions with placeholder identifiers; retrieving multiple advertisements suitable for insertion; ranking the advertisements based on contextual relevance to the placeholders; selecting an advertisement for each placeholder based on ranking; resizing and harmonizing each advertisement to fit its assigned placeholder; inserting the harmonized advertisements into their respective placeholders.

Some embodiments provide a method for interactive advertisement integration into videos, comprising: detecting and tagging objects within video frames that can serve as interactive elements; analyzing the advertisement content to identify interactive features; generating a clickable overlay for the advertisement content; linking the overlay to an external web or shopping resource; resizing and positioning the advertisement to align with the tagged interactive object; blending the clickable overlay with the advertisement content; dynamically integrating the interactive advertisement into the video during playback.

Some embodiments provide a method for adaptive advertisement sequencing in videos, comprising: dividing the target video into multiple sequential segments; analyzing each segment's context and visual characteristics; ranking the segments based on their suitability for advertisement insertion; determining the sequence of advertisement types to match segment contexts; resizing and harmonizing each advertisement to align with its corresponding segment; inserting the advertisements sequentially into the identified segments; ensuring smooth transitions between each segment and its advertisement.

Some embodiments may further utilize localization data and/or geo-location data, to further select relevant ads and/or to take this information into account during video processing. For example, some embodiments provide a method for localized advertisement insertion into videos, comprising: detecting geographical metadata associated with the video content; analyzing the advertisement content for regional relevance; filtering the advertisements to select region-specific options; resizing and harmonizing the selected advertisement to match the video's visual and tonal context; appending a localized text or logo overlay to the advertisement; inserting the adjusted advertisement into the video at region-appropriate segments; dynamically adjusting the advertisement based on real-time location data during playback.

Some embodiments may further utilize predictive analytics in video advertisement integration. For example, the method may include: analyzing historical data on advertisement effectiveness for similar video types; extracting visual and contextual patterns from the target video; predicting viewer engagement for different advertisement types using a trained model; selecting an advertisement type most likely to achieve high engagement; resizing and harmonizing the selected advertisement to match the video context; determining the optimal insertion point based on engagement predictions; integrating the adjusted advertisement into the video at the predicted point.

Some embodiments may include, or may provide, some or all of the following features or operations or benefits. (1) Dynamic Contextual Matching, as the system automatically matches advertisements to video segments based on visual, audio, and contextual analysis, ensuring seamless integration without disrupting the viewing experience. (2) AI-Based Harmonization, as the system can apply deterministic based and/or AI-driven color correction, grading, and audio normalization to blend advertisements seamlessly with the target video's look-and-feel. (3) Temporal Insertion Optimization, as the system identifies the best time-points in a video for advertisement insertion using scene detection, contextual analysis, and audience engagement metrics. (4) Spatial Placement Engine, as the system detects placeholders in video frames for spatial advertisement insertion, enabling precise placement of ads onto surfaces or objects. (5) Generative AI Transitions, as the system creates synthetic video transitions and/or audio transitions between advertisements and videos, enhancing visual and auditory continuity. (6) Interactive Ad Elements, as the system can incorporate clickable overlays or interactive components into advertisements, allowing viewers to engage directly with the content. (7) Regulatory Compliance Features, as the system can automatically detect segments requiring disclaimers or restrictions and appends visual or textual indicators to ensure adherence to advertising regulations. (8) Localized Advertisement Targeting, as the system can tailor advertisements based on geographic metadata of the target video and/or of the advertisement and/or based on geo-location data of the viewer, and/or based on geographic region insights that the VLM can deduce from the target video and/or from the advertisement content, ensuring relevance and appeal for specific regions or audiences. (9) Accessibility Enhancements, as some embodiments can be configured to add captions, textual descriptions, and synchronized metadata to advertisements, improving accessibility for visually or hearing-impaired viewers. (10) Predictive Ad Placement, as some embodiments can optionally utilize Machine Learning (ML) to predict viewer engagement and select the most suitable advertisement types and insertion points. (11) Multi-Ad Integration, as the system enables simultaneous insertion of multiple advertisements, distributing them spatially and temporally across the video content. (12) Smart Object Replacement, as the system replaces objects in video frames with advertisement content using AI-driven inpainting and spatial harmonization techniques. (13) Look-and-Feel Metrics, as the system quantifies visual characteristics of videos and advertisements, creating compatibility scores to guide seamless integration. (14) Thematic Ad Matching, as the system aligns advertisements with the thematic elements of video segments, enhancing contextual relevance and viewer engagement. (15) Content-Sensitive Audio Harmonization, as the system can blend advertisement audio with the target video's soundtrack by adjusting volume, tone, and background effects. (16) Placeholder Detection Flexibility, as the system can support “Add” and “Replace” modes for advertisement placement, dynamically switching based on available placeholders and/or based on the mode that would be least disruptive and most smoothly absorbed by the viewer. (17) Transparency Indicators, as the system can adds visual labels (or watermarks) to indicate AI-modified advertisement content, promoting transparency and viewer trust. (18) Cross-Platform Compatibility, as the system can integrate seamlessly across diverse video playback platforms, including web browsers, computers, gaming consoles, mobile devices, and AR/VR/XR/MR systems.

Some embodiments may include or may utilize some, or most, or all, of the following components and/or units. (1) Video Provider System, that delivers the original target video to the media player, enabling playback and advertisement integration. (2) Video/Media Player, that processes video streams, connects to ad providers, and in some embodiments also locally handles the integration of advertisements into the video during playback. (3) Advertisement Exchange System, that acts as an intermediary to select and retrieve advertisement content from multiple providers based on contextual requirements. (4) Advertisement Provider System, that stores and supplies the advertisement content, including video segments, images, and metadata, for insertion into the target video. (5) Temporal Insertion Scheduler, that determines the precise time-points within the video for seamless temporal advertisement insertion. (6) Spatial Insertion Module, that identifies locations within video frames for placing advertisement content, such as surfaces or replaceable objects. (7) Harmonization Module, that adjusts or modifies advertisement content to match the video's look-and-feel, including lighting, colors, and context. (8) Generative Transition Unit, that generates smooth transitions between video content and advertisements for temporal and visual continuity. (9) Color Correction Processor, that aligns advertisement color tones with the lighting and color balance of the target video frames. (10) Object Detection Engine, that identifies objects or regions in video frames to serve as placeholders for spatial advertisement insertion. (11) Inpainting Unit, that removes existing objects in video frames and replaces them with advertisement content while maintaining visual consistency. (12) Depth Mapping Processor, that can optionally be used to estimate depth in video frames in order to better align advertisements with spatial perspectives. (13) Placeholder Tagging Unit, that tags detected objects or regions as potential placeholders for adding or replacing advertisement content. (14) Perspective Alignment Unit, that can optionally adjust or modify the advertisement content's orientation or slanting or tilting to match the perspective of the relevant video frame(s). (15) Audio Synchronization Unit, that can align the advertisement's audio track with the target video's audio track for seamless integration. (16) Advertisement Resizing Module, that can adjust or increase or decrease or resize the dimensions of advertisement content to fit placeholders or defined spatial regions in the video. (17) Contrast Normalization Engine, that balances advertisement contrast to blend with the surrounding video frame characteristics. (18) Temporal Sequence Controller, that manages the order and duration of advertisement content inserted into videos. (19) Video Segmenting Unit, that can segment a target video into video-segments having differential time-length, based on visual content depicted in each segment and/or based on audio track of each segment and/or based on contextual content analysis of each segment and/or based on the look-and-feel characteristics of each segment. (20) Contextual Matching Engine, that can match advertisement content with the video based on extracted themes, visual characteristics, and context. (21) Transition Effect Repository or Pool or Bank, that provides pre-defined effects for smoothing transitions between video content and advertisements. (22) AI-Based Placement Evaluator, that analyzes possible advertisement placement locations and selects the most visually appealing and contextually relevant spots. (23) Video Metadata Extractor, that extracts metadata from the video stream, such as HDR, frame duration, scene duration, and/or other attributes, to inform advertisement placement. (24) VLM-Based Context Analyzer, that generates embeddings for video frames and advertisements, facilitating contextual alignment. (25) Multi-Ad Integration Coordinator, that enables the insertion of multiple advertisements into a single target video, ensuring harmonious distribution throughout the video. (26) Advertisement Streaming Controller, that streams selected advertisement content to the media player for real-time integration into the video. (27) Edge Detection Module, that identifies edges and boundaries of objects within video frames to precisely position advertisement content. (28) Brightness Balancing Tool, that equalizes brightness between advertisement content and video frames for seamless integration. (29) Dynamic Scaling Unit, that adapts advertisement content sizes dynamically to fit varying frame dimensions and resolutions. (30) Video Object Tracker, that can optionally track an object across video frames, to synchronize advertisement placement with motion or with a moving scenery, or in a video where the camera is moving relative to the scenery. (31) Interactive Overlay Generator, that can create interactive elements for advertisements, such as clickable regions or embedded links. (32) Look-and-Feel Harmonizer Unit, that ensures visual and thematic consistency between advertisement content and video frames. (33) Scene Transition Manager, that manages entry and exit points for advertisements within scene transitions of the video. (34) Real-Time Rendering Engine, that processes and inserts advertisement content dynamically during video playback. (35) Advertisement Logging Unit, that tracks and records the placement and performance of advertisements for analysis and reporting.

Some embodiments provide a computerized method, comprising: (a) automatically performing a look-and-feel harmonization process, between (i) a target video, and (ii) an advertisement video that is intended for insertion into said target video, by automatically modifying visual characteristics of the advertisement video to increase a level of visual matching between the target video and the advertisement video, and by generating a harmonized version of the advertisement video that is tailored to suitably match the look-and-feel of the target video; (b) invoking an Artificial Intelligence (AI) model to automatically analyze content of the target video, and to determine a particular time-point in the target video at which the harmonized version of the advertisement video can be suitably inserted via temporal insertion; (c) performing temporal insertion of the harmonized version of the advertisement video into the target video, at said particular time-point in the target video, to generate a combined and harmonized video output.

In some embodiments, step (b) of invoking the AI model comprises: invoking a Vision-and-Language Model (VLM) that is prompted (I) to analyze the target video and (II) to analyze the advertisement video and (III) to find one or more candidate time-points in the target video at which the harmonized version of the advertisement video can be suitably inserted via temporal insertion.

In some embodiments, the method comprises: selecting by the VLM a particular candidate time-point of the target video, out of a plurality of candidate time-points that were generated by the VLM, based on a VLM-generated estimation of which candidate time-point will result in the most visually-appealing matching between the target video and the advertisement video and will be least intrusive both contextually and visually.

In some embodiments, performing the look-and-feel harmonization process comprises at least: performing color correction on the advertisement video, and also performing color grading on the advertisement video, to increase a matching between: (i) look-and-feel characteristics of the advertisement video, and (ii) look-and-feel characteristics of the target video.

In some embodiments, performing the look-and-feel harmonization process comprises at least: automatically selecting and applying an on-start visual transition effect, and applying it to a beginning portion of the advertisement video, to generate a visually-smooth and harmonized transition from the target video to the advertisement video; wherein the selecting is performed by selecting an on-start visual transition effect from a pool of pre-defined visual transition effects, based on an estimation of which particular on-start visual transition effect is expected to contribute the most to said visually-smooth and harmonized transition from the target video to the advertisement video.

In some embodiments, performing the look-and-feel harmonization process comprises at least: automatically selecting and applying an on-end visual transition effect, and applying it to an ending portion of the advertisement video, to generate a visually-smooth and harmonized transition from the advertisement video back to the target video; wherein the selecting is performed by selecting an on-end visual transition effect from a pool of pre-defined visual transition effects, based on an estimation of which particular on-end visual transition effect is expected to contribute the most to said visually-smooth and harmonized transition from the advertisement video back to the target video.

In some embodiments, performing the look-and-feel harmonization process comprises at least: automatically generating, by a Generative Artificial Intelligence (Gen-AI) engine an on-start visual transition effect, that is automatically applied to or appended before a beginning portion of the advertisement video, to generate a visually-smooth and harmonized transition from the target video to the advertisement video; wherein the Gen-AI engine is configured to generate said on-start visual transition effect by taking into account visual content of the target video and visual content of the advertisement video.

In some embodiments, performing the look-and-feel harmonization process comprises at least: automatically generating, by a Generative Artificial Intelligence (Gen-AI) engine an on-end visual transition effect, that is automatically applied to or appended after an ending portion of the advertisement video, to generate a visually-smooth and harmonized transition from the advertisement video back to the target video; wherein the Gen-AI engine is configured to generate said on-end visual transition effect by taking into account visual content of the target video and visual content of the advertisement video.

In some embodiments, wherein the target video is a target audio-and-video that has a target video track and a target audio track; wherein the advertisement video is an advertisement audio-and-video that has an advertisement video track and an advertisement audio track; wherein step (b) of invoking the AI model comprises: invoking a Large Multi-Modalities Model (LMMM) that is prompted (I) to analyze the target video track, and (II) to analyze the advertisement video track, and (III) to analyze the target audio track, and (IV) to analyze the advertisement audio track, and (V) to find candidate time-points in the target video at which the harmonized version of the advertisement video can be suitably inserted via temporal insertion to achieve a visually-matching and an audibly-matching combination of the target video and the advertisement video.

In some embodiments, invoking a Vision-and-Language Model (VLM) that is prompted to analyze the target video and to generate a textual summary of the target video; invoking the Vision-and-Language Model (VLM) that is prompted to analyze the advertisement video and to generate a textual summary of the advertisement video; invoking a Large Language Model (LMM), to perform analysis of the textual summary of the target video and to perform analysis of the textual summary of the advertisement video, and to generate proposals for candidate time-points at which the harmonized version of the advertisement video can be suitably inserted via temporal insertion.

Some embodiments provide a computer-based method, comprising: (a) automatically performing a look-and-feel harmonization process, between (i) a target video, and (ii) an advertisement product-image that is intended for spatial insertion into some video-frames of said target video, by automatically modifying visual characteristics of the advertisement product-image to increase a level of visual matching between the target video and the advertisement product-image, and by generating a harmonized version of the advertisement product-image that is tailored to suitably match the look-and-feel of the target video; (b) invoking an Artificial Intelligence (AI) model to automatically analyze content of the target video, and to determine particular video-frames of the target video that have frame-regions that the AI model determines to be suitable for adding therein the harmonized version of the advertisement product-image; wherein said adding comprises an in-frame spatial insertion that is one of: (i) adding into a frame-region that is not occupied by another object, (ii) replacing an object in said particular video-frames with the harmonized version of the advertisement product-image; (c) performing spatial insertion of the harmonized version of the advertisement product-image into the target video, at said frame-regions of said particular video-frames.

In some embodiments, the advertisement product-image is one of: a single image of a product; a single video-frame extracted from an animation of a product; a single video-frame extracted from a video of a product; a set of video-frames extracted from an animation of a product; a set of video-frames extracted from a video of a product.

In some embodiments, step (b) of invoking the AI model comprises: performing VLM analysis of both (I) the target video, and (ii) the advertisement product-image, and generating a VLM-based decision indicating candidate spatial placeholders in particular video-frames of the target video, wherein each candidate spatial placeholder indicates a spatial location that the VLM determined to be suitable for in-frame spatial insertion of a visual depiction of the product from the advertisement product-image.

In some embodiments, the method comprises: selecting by the VLM a particular spatial placeholder, out of a plurality of VLM-generated candidate spatial placeholders, based on a generated VLM estimation of which particular candidate spatial placeholder will result in at least one of: (I) the most visually-appealing result to a human viewer and would enable visually-smooth insertion of the visual depiction of the product from the advertisement product-image, (II) the highest visual matching between (i) the look-and-feel characteristics of said product and (ii) the look-and-feel characteristics of the target video.

In some embodiments, the method comprises: performing color correction on a frame-by-frame basis, and performing color grading on a frame-by-frame basis, to visually match an in-frame spatially-inserted product from the advertisement product-image to nearby frame-regions of video-frames of the target video.

In some embodiments, the method comprises: performing VLM analysis of both (I) the target video, and (ii) the advertisement product-image, and generating a VLM-based decision in which the VLM automatically selects one of: (I) to add the depiction of the product from the advertisement product-image into an unoccupied frame-region of video-frames of the target video, or (II) to replace an already-depicted item in particular video-frames of the target video with said depiction of the product from the advertisement product-image.

In some embodiments, the method comprises: automatically adding a visual indicator, to video-frames that were modified by inserting into them the product from the advertisement product-image, to indicate that those video-frames were synthetically modified to depict an item that did not appear in an original version of the target video.

In some embodiments, the advertisement product-image is one of: a set of video-frames extracted from an animation of a product; a set of video-frames extracted from a video of a product; wherein said set of video-frames depicts the product in a plurality of states that form an animated sequence or a visually-changing sequence. In some embodiments, the method comprises: performing harmonization between (I) the look-and-feel of said set of video-frames that depicts the product in a plurality of states, and (II) the look-and-feel of the target video; and performing insertion of said set of video-frames that depicts the product in a plurality of states into a particular location across a plurality of video-frames in the target video.

Some embodiments include a non-transitory storage medium or storage article having stored thereon instructions that, when executed by a machine or a hardware processor, cause the machine or the hardware processor to perform a method as described.

Some embodiments include a system comprising: one or more hardware processors, that are configured to execute code, and that are operably associated with one or more memory units that are configured to store code; wherein the one or more hardware processors are configured to perform a method as described.

In some embodiments, in order to perform the computerized operations described above, the relevant system or devices may be equipped with suitable hardware components and/or software components; for example: a processor able to process data and/or execute code or machine-readable instructions (e.g., a central processing unit (CPU), a graphic processing unit (GPU), a digital signal processor (DSP), a processing core, an Integrated Circuit (IC), an Application-Specific IC (ASIC), one or more controllers, a logic unit, or the like); a memory unit able to store data for short term (e.g., Random Access Memory (RAM), volatile memory); a storage unit able to store data for long term (e.g., non-volatile memory, Flash memory, hard disk drive, solid state drive, optical drive); an input unit able to receive user's input (e.g., keyboard, keypad, mouse, touch-pad, touch-screen, microphone); an output unit able to generate or produce or provide output (e.g., screen, touch-screen, monitor, display unit, audio speakers); one or more transceivers or transmitters or receivers or communication units (e.g., Wi-Fi transceiver, cellular transceiver, Bluetooth transceiver, wireless communication transceiver, wired transceiver, Network Interface Card (NIC), modem); and other suitable components (e.g., a power source, an Operating System (OS), drivers, applications or “apps” or software modules, or the like).

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, AJAX, XML, JSON, Lisp, Eiffel, Verilog, Hardware Description Language (HDL), Visual BASIC, MATLAB, Pascal, HTML, HTML5, CSS, Perl, Python, PHP, Dart, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wide Area Network (WAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A computerized method, comprising:
(a) automatically performing a look-and-feel harmonization process, between (i) a target video, and (ii) an advertisement video that is intended for insertion into said target video, by automatically modifying visual characteristics of the advertisement video to increase a level of visual matching between the target video and the advertisement video, and by generating a harmonized version of the advertisement video that is tailored to suitably match the look-and-feel of the target video;
(b) invoking an Artificial Intelligence (AI) model to automatically analyze content of the target video, and to determine a particular time-point in the target video at which the harmonized version of the advertisement video can be suitably inserted via temporal insertion;
(c) performing temporal insertion of the harmonized version of the advertisement video into the target video, at said particular time-point in the target video, to generate a combined and harmonized video output.

2. The computerized method of claim 1,
wherein step (b) of invoking the AI model comprises:
invoking a Vision-and-Language Model (VLM) that is prompted (I) to analyze the target video and (II) to analyze the advertisement video and (III) to find one or more candidate time-points in the target video at which the harmonized version of the advertisement video can be suitably inserted via temporal insertion.

3. The computerized method of claim 2, comprising:
selecting by the VLM a particular candidate time-point of the target video, out of a plurality of candidate time-points that were generated by the VLM, based on a VLM-generated estimation of which candidate time-point will result in the most visually-appealing matching between the target video and the advertisement video and will be least intrusive both contextually and visually.

4. The computerized method of claim 3,
wherein performing the look-and-feel harmonization process comprises at least:
performing color correction on the advertisement video, and also performing color grading on the advertisement video, to increase a matching between: (i) look-and-feel characteristics of the advertisement video, and (ii) look-and-feel characteristics of the target video.

5. The computerized method of claim 1,
wherein performing the look-and-feel harmonization process comprises at least:
automatically selecting and applying an on-start visual transition effect, and applying it to a beginning portion of the advertisement video, to generate a visually-smooth and harmonized transition from the target video to the advertisement video;
wherein the selecting is performed by selecting an on-start visual transition effect from a pool of pre-defined visual transition effects, based on an estimation of which particular on-start visual transition effect is expected to contribute the most to said visually-smooth and harmonized transition from the target video to the advertisement video.

6. The computerized method of claim 1,
wherein performing the look-and-feel harmonization process comprises at least:
automatically selecting and applying an on-end visual transition effect, and applying it to an ending portion of the advertisement video, to generate a visually-smooth and harmonized transition from the advertisement video back to the target video;
wherein the selecting is performed by selecting an on-end visual transition effect from a pool of pre-defined visual transition effects, based on an estimation of which particular on-end visual transition effect is expected to contribute the most to said visually-smooth and harmonized transition from the advertisement video back to the target video.

7. The computerized method of claim 1,
wherein performing the look-and-feel harmonization process comprises at least:
automatically generating, by a Generative Artificial Intelligence (Gen-AI) engine an on-start visual transition effect, that is automatically applied to or appended before a beginning portion of the advertisement video, to generate a visually-smooth and harmonized transition from the target video to the advertisement video;
wherein the Gen-AI engine is configured to generate said on-start visual transition effect by taking into account visual content of the target video and visual content of the advertisement video.

8. The computerized method of claim 1,
wherein performing the look-and-feel harmonization process comprises at least:
automatically generating, by a Generative Artificial Intelligence (Gen-AI) engine an on-end visual transition effect, that is automatically applied to or appended after an ending portion of the advertisement video, to generate a visually-smooth and harmonized transition from the advertisement video back to the target video;
wherein the Gen-AI engine is configured to generate said on-end visual transition effect by taking into account visual content of the target video and visual content of the advertisement video.

9. The computerized method of claim 1,
wherein the target video is a target audio-and-video that has a target video track and a target audio track;
wherein the advertisement video is an advertisement audio-and-video that has an advertisement video track and an advertisement audio track;
wherein step (b) of invoking the AI model comprises:
invoking a Large Multi-Modalities Model (LMMM) that is prompted (I) to analyze the target video track, and (II) to analyze the advertisement video track, and (III) to analyze the target audio track, and (IV) to analyze the advertisement audio track, and (V) to find one or more candidate time-points in the target video at which the harmonized version of the advertisement video can be suitably inserted via temporal insertion to achieve a visually-matching and an audibly-matching combination of the target video and the advertisement video.

10. The computerized method of claim 1, comprising:
invoking a Vision-and-Language Model (VLM) that is prompted to analyze the target video and to generate a textual summary of the target video;
invoking the Vision-and-Language Model (VLM) that is prompted to analyze the advertisement video and to generate a textual summary of the advertisement video;
invoking a Large Language Model (LMM), to perform analysis of the textual summary of the target video and to perform analysis of the textual summary of the advertisement video, and to generate proposals for candidate time-points at which the harmonized version of the advertisement video can be suitably inserted via temporal insertion.

11. A computer-based method, comprising:
(a) automatically performing a look-and-feel harmonization process, between (i) a target video, and (ii) an advertisement product-image that is intended for spatial insertion into some video-frames of said target video, by automatically modifying visual characteristics of the advertisement product-image to increase a level of visual matching between the target video and the advertisement product-image, and by generating a harmonized version of the advertisement product-image that is tailored to suitably match the look-and-feel of the target video;
(b) invoking an Artificial Intelligence (AI) model to automatically analyze content of the target video, and to determine particular video-frames of the target video that have frame-regions that the AI model determines to be suitable for adding therein the harmonized version of the advertisement product-image; wherein said adding comprises an in-frame spatial insertion that is one of: (i) adding into a frame-region that is not occupied by another object, (ii) replacing an object in said particular video-frames with the harmonized version of the advertisement product-image;
(c) performing spatial insertion of the harmonized version of the advertisement product-image into the target video, at said frame-regions of said particular video-frames.

12. The computer-based method of claim 11,
wherein the advertisement product-image is one of:
a single image of a product;
a single video-frame extracted from an animation of a product;
a single video-frame extracted from a video of a product;
a set of video-frames extracted from an animation of a product;
a set of video-frames extracted from a video of a product.

13. The computer-based method of claim 12,
wherein step (b) of invoking the AI model comprises:
performing VLM analysis of both (I) the target video, and (ii) the advertisement product-image, and generating a VLM-based decision indicating candidate spatial placeholders in particular video-frames of the target video, wherein each candidate spatial placeholder indicates a spatial location that the VLM determined to be suitable for in-frame spatial insertion of a visual depiction of the product from the advertisement product-image.

14. The computer-based method of claim 13, comprising:
selecting by the VLM a particular spatial placeholder, out of a plurality of VLM-generated candidate spatial placeholders, based on a generated VLM estimation of which particular candidate spatial placeholder will result in at least one of: (I) the most visually-appealing result to a human viewer and would enable visually-smooth insertion of the visual depiction of the product from the advertisement product-image, (II) the highest visual matching between (i) the look-and-feel characteristics of said product and (ii) the look-and-feel characteristics of the target video.

15. The computer-based method of claim 12, comprising:
performing color correction on a frame-by-frame basis, and performing color grading on a frame-by-frame basis, to visually match an in-frame spatially-inserted product from the advertisement product-image to nearby frame-regions of video-frames of the target video.

16. The computer-based method of claim 12, comprising:
performing VLM analysis of both (I) the target video, and (ii) the advertisement product-image, and generating a VLM-based decision in which the VLM automatically selects one of: (I) to add the depiction of the product from the advertisement product-image into an unoccupied frame-region of video-frames of the target video, or (II) to replace an already-depicted item in particular video-frames of the target video with said depiction of the product from the advertisement product-image.

17. The computer-based method of claim 12, comprising:
automatically adding a visual indicator, to video-frames that were modified by inserting into them the product from the advertisement product-image, to indicate that those video-frames were synthetically modified to depict an item that did not appear in an original version of the target video.

18. The computer-based method of claim 11,
wherein the advertisement product-image is one of:
a set of video-frames extracted from an animation of a product;
a set of video-frames extracted from a video of a product;
wherein said set of video-frames depicts the product in a plurality of states that form an animated sequence or a visually-changing sequence;
wherein the computer-based method comprises:
performing harmonization between (I) the look-and-feel of said set of video-frames that depicts the product in a plurality of states, and (II) the look-and-feel of the target video; and
performing insertion of said set of video-frames that depicts the product in a plurality of states into a particular location across a plurality of video-frames in the target video.

19. A system comprising:
one or more hardware processors, that are configured to execute code,
and that are operably associated with one or more memory units that are configured to store code and data,
wherein the one or more hardware processors are configured to perform a computerized method comprising:
(a) automatically performing a look-and-feel harmonization process, between (i) a target video, and (ii) an advertisement video that is intended for insertion into said target video, by automatically modifying visual characteristics of the advertisement video to increase a level of visual matching between the target video and the advertisement video, and by generating a harmonized version of the advertisement video that is tailored to suitably match the look-and-feel of the target video;
(b) invoking an Artificial Intelligence (AI) model to automatically analyze content of the target video, and to determine a particular time-point in the target video at which the harmonized version of the advertisement video can be suitably inserted via temporal insertion;
(c) performing temporal insertion of the harmonized version of the advertisement video into the target video, at said particular time-point in the target video, to generate a combined and harmonized video output.

20. A system comprising:
one or more hardware processors, that are configured to execute code,
and that are operably associated with one or more memory units that are configured to store code and data,
wherein the one or more hardware processors are configured to perform a computer-based method comprising:
(a) automatically performing a look-and-feel harmonization process, between (i) a target video, and (ii) an advertisement product-image that is intended for spatial insertion into some video-frames of said target video, by automatically modifying visual characteristics of the advertisement product-image to increase a level of visual matching between the target video and the advertisement product-image, and by generating a harmonized version of the advertisement product-image that is tailored to suitably match the look-and-feel of the target video;
(b) invoking an Artificial Intelligence (AI) model to automatically analyze content of the target video, and to determine particular video-frames of the target video that have frame-regions that the AI model determines to be suitable for adding therein the harmonized version of the advertisement product-image; wherein said adding comprises an in-frame spatial insertion that is one of: (i) adding into a frame-region that is not occupied by another object, (ii) replacing an object in said particular video-frames with the harmonized version of the advertisement product-image;
(c) performing spatial insertion of the harmonized version of the advertisement product-image into the target video, at said frame-regions of said particular video-frames.
